(19) United States
(12) Patent Application Publication
(10) Pub. No.: US 2016/0011792 A1
(43) Pub. Date: Jan. 14, 2016

(54) MEDIA CONTROL DEVICE AND CONTROL METHOD

(71) Applicant: FUJITSU LIMITED, Kawasaki-shi (JP)

(72) Inventors: Nobuyuki Hirashima, Nagano (JP); Fumio Matsuo, Nagano (JP); Katsuo Enohara, Kawaguchi (JP); Takaaki Yamato, Nagano (JP); Takashi Murayama, Nagano (JP); Toshiaki Takeuchi, Nagano (JP); Hidetoshi Nishi, Nagano (JP); Ryota TSUKAHARA, Kawasaki (JP)

(73) Assignee: FUJITSU LIMITED, Kawasaki (JP)

(21) Appl. No.: 14/750,175

(22) Filed: Jun. 25, 2015

(30) Foreign Application Priority Data
Jul. 9, 2014 (JP) 2014-141779

(51) Int. Cl. G06F 3/06

(52) U.S. Cl. CPC G06F 3/0611; G06F 3/0644; G06F 3/0659; G06F 3/0664; G06F 3/0686

(57) ABSTRACT

A media control device includes a processor. The processor is configured to read out, in response to a first request received from an information processing apparatus, part of a plurality of divided data items from recording media and store the part of the plurality of divided data items in a first storage unit. The plurality of divided data items are obtained by dividing a first set of data and stored in the recording media. The processor is configured to access, in response to a second request received from the information processing apparatus, one divided data item stored in the first storage unit.

### CROSS-REFERENCE TO RELATED APPLICATION

This application is based upon and claims the benefit of priority of the prior Japanese Patent Application No. 2014-141779 filed on Jul. 9, 2014, the entire contents of which are incorporated herein by reference.

### FIELD

The embodiments discussed herein are related to a media control device and a control method.

### BACKGROUND

When connected to a host apparatus, a virtual tape system may virtually act as a tape library for the host apparatus. The host apparatus connected to this type of virtual tape system recognizes the virtual tape system as a tape library apparatus. The host apparatus transmits an instruction (WRITE instruction) to write data (WRITE data) and an instruction (READ instruction) to read out data (READ data) to the recognized apparatus and receives results for these instructions.

FIG. 1 illustrates an exemplary configuration of a virtual tape system. The virtual tape system includes a virtual tape apparatus and a tape library apparatus. The virtual tape apparatus includes a control server that performs various types of control for the virtual tape apparatus and also includes a disk array apparatus in which data is stored. The tape library apparatus includes at least one tape drive and a plurality of slots in which tape cartridges are inserted. The tape library apparatus has functions of writing data to and reading data from a tape cartridge set in the tape drive and of replacing the set tape cartridge. The tape cartridge is, for example, a magnetic tape such as a linear tape-open (LTO) tape.

The virtual tape apparatus is connected to a host apparatus at a front end and is connected to the tape library apparatus at a back end. The virtual tape apparatus and the host apparatus are interconnected through, for example, a communication network. The virtual tape apparatus and the tape library apparatus are also interconnected through, for example, a communication network. Upon receipt of WRITE data from the host apparatus, the control server first stores the WRITE data in the disk array apparatus in the virtual tape apparatus and then saves (stores) the data from the disk array apparatus to a tape in the tape library apparatus. An operation to save data tentatively stored in a predetermined storage area (disk array) in the virtual tape apparatus to a tape in the tape library apparatus in this way is called “migration”. Due to migration, data integrity is assured.

If the disk array apparatus has no free space in which WRITE data received from the host apparatus is to be stored, the control server performs control as described below. When the control server receives the WRITE data from the host apparatus, the control server removes (deletes) data that is least accessed in the disk array apparatus to make a disk space and writes new data to the space. An operation to remove data from a predetermined storage unit (disk array) in the virtual tape apparatus is called “off-cache”.

Upon receipt of a READ instruction from the host apparatus, the control server checks whether target READ data is stored in the disk array apparatus. If the data is stored in the disk array apparatus, the control server sends the data to the host apparatus. If the target READ data is not stored in the disk array apparatus, the control server reads out the target data from a tape in the tape library apparatus and loads (stores) the read-out data in the disk array apparatus. The control server sends the loaded data to the host apparatus. An operation to load data from a tape in the tape library apparatus to a predetermined storage area (disk array) in the virtual tape apparatus is called “recall”.

This recall processing is performed not only when a READ instruction is received from the host apparatus but also when a WRITE instruction is received. That is, as in the case of a READ instruction, the control server checks whether target WRITE data is stored in the disk array. If the target WRITE data is not stored in the disk array, the control server performs a recall. The reason why load processing is performed in write processing as well is that it is difficult to determine whether data specified by the host apparatus is data on which to perform write processing or data on which to perform read processing until data transfer starts between the host apparatus and the virtual tape apparatus.

In a specific operation to receive a WRITE instruction or READ instruction from the host apparatus, the control server first mounts, in a virtual tape drive (logical drive) of the virtual tape apparatus, a logical volume (LV) in which target WRITE or READ data is stored. If the target WRITE or READ data is present in the disk array, the control server mounts, in the logical drive, a target data partition of the disk array. Upon completion of the mounting, the control server executes the instruction received from the host apparatus. If the target data is not present in the disk array, the control server first mounts, in the logical drive, the specified partition of the disk array, and loads the data from the tape library apparatus. Thereafter, the control server executes the instruction received from the host apparatus.

Related techniques are disclosed in, for example, Japanese Laid-open Patent Publication No. 10-232800, Japanese National Publication of International Patent Application No. 2003-513352, Japanese National Publication of International Patent Application No. 2005-537555, and Japanese Laid-open Patent Publication No. 2013-161256.

Before executing a WRITE instruction or READ instruction received from a host apparatus, a virtual tape apparatus mounts a logical volume in a logical drive and loads data of the logical volume in a disk array. Therefore, if target WRITE or READ data is off-cached data, the virtual tape apparatus reads out, from a tape cartridge, the data of the logical volume by recall processing and loads the read-out data in the disk array.

Recently, the amount of data to be handled tends to increase and the amount of logical volume handled in a virtual tape apparatus is also increasing. In recall processing, as the amount of data increases, much more time is taken in read processing from a tape library to a disk array. While recall processing is in progress, the host apparatus is placed in a wait state. If the amount of data is large, a time-out set by the host apparatus may be reached at worst.

### SUMMARY

According to an aspect of the present invention, provided is a media control device including a processor. The processor is configured to read out, in response to a first request received from an information processing apparatus, part of a plurality of divided data items from recording media and store the part of the plurality of divided data items in a first storage unit. The plurality of divided data items are obtained by dividing a first set of data and stored in the recording media. The processor is configured to access, in response to a second request received from the information processing apparatus, one divided data item stored in the first storage unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary configuration of a virtual tape system;

FIG. 2 is a flowchart illustrating an exemplary flow of processing performed by an existing virtual tape system;

FIG. 3 illustrates an exemplary configuration of a virtual tape system according to an embodiment;

FIG. 4 illustrates write processing performed by a virtual tape system according to an embodiment;

FIG. 5 illustrates read processing from the beginning of a target volume performed in a virtual tape system according to an embodiment;

FIG. 6 illustrates processing on a move command performed in a virtual tape system according to an embodiment;

FIG. 7 illustrates an exemplary media control device according to an embodiment:

FIG. 8 illustrates an exemplary configuration of a control unit according to an embodiment:

FIG. 9 illustrates an exemplary structure of management information;

FIG. 10 illustrates an example of LV list information;

FIG. 11 illustrates a certain specific portion of data of a target volume;

FIG. 12A illustrates existing mount processing and time taken therein to process a move command;

FIG. 12B illustrates mount processing in a virtual tape system according to an embodiment and time taken therein to process a move command;

FIG. 13A illustrates existing mount processing and time taken therein in write processing from the beginning;

FIG. 13B illustrates mount processing in a virtual tape system according to an embodiment and time taken therein in write processing from the beginning;

FIG. 14A illustrates existing mount processing and time taken therein in additional-write processing from an intermediate point;

FIG. 14B illustrates mount processing in a virtual tape system according to an embodiment and time taken therein in additional-write processing from an intermediate point;

FIG. 15A illustrates existing mount processing and time taken therein in read processing from the beginning;

FIG. 15B illustrates mount processing in a virtual tape system according to an embodiment and time taken therein in read processing from the beginning;

FIG. 16A illustrates existing mount processing and time taken therein in read processing from an intermediate point;

FIG. 16B illustrates mount processing in a virtual tape system according to an embodiment and time taken therein in read processing from an intermediate point;

FIG. 17 illustrates an operation performed to off-cache a plurality of divided volumes of a plurality of logical volumes;

FIG. 18 is a flowchart illustrating details of mount processing performed by a mount processing unit according to an embodiment;

FIG. 19 is a flowchart illustrating details of write processing performed by a write processing unit according to an embodiment;

FIG. 20 is a flowchart illustrating details of migration processing performed by a migration processing unit according to an embodiment;

FIG. 21 is a flowchart illustrating details of off-cache processing performed by an off-cache processing unit according to an embodiment;

FIG. 22 is a flowchart illustrating details of off-cache processing performed by an off-cache processing unit according to an embodiment;

FIG. 23 is a flowchart illustrating details of read processing performed by a read processing unit according to an embodiment;

FIG. 24 is a flowchart illustrating details of first recall processing performed by a mount processing unit according to an embodiment;

FIG. 25 is a flowchart illustrating details of move processing performed by a move processing unit according to an embodiment;

FIG. 26 is a flowchart illustrating details of second recall processing according to an embodiment; and

FIG. 27 illustrates an exemplary hardware configuration of a control unit according to an embodiment.

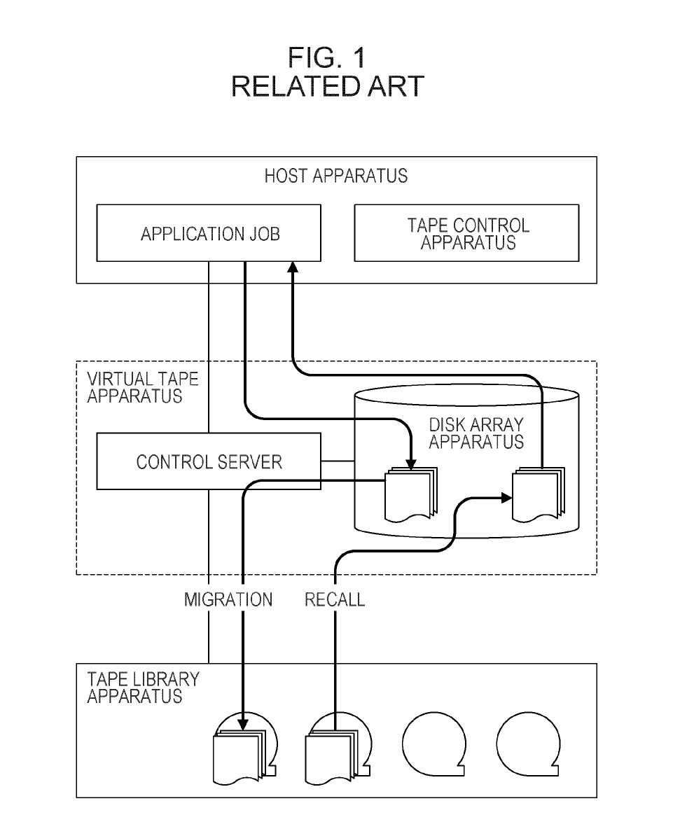

### DESCRIPTION OF EMBODIMENTS

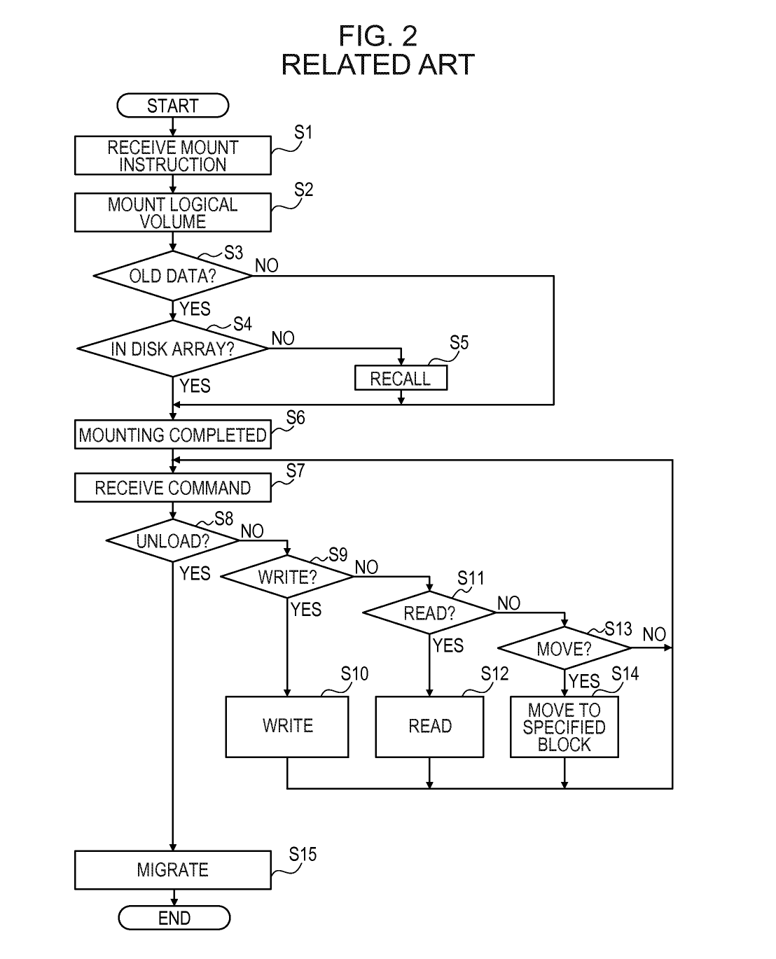

First, an example of a flow of processing performed by an existing virtual tape system will be described. FIG. 2 is a flowchart illustrating the flow of processing performed by the existing virtual tape system.

In FIG. 2, a control server in the virtual tape system first receives a MOUNT instruction from a host apparatus connected to the virtual tape system (S1). In response to the MOUNT instruction received in S1, the control server mounts, in a logical drive, a target volume specified as a target for the MOUNT instruction (S2).

The control server then determines whether old data is already stored in the target volume mounted in S2 (S3). If the control server determines that old data is not yet stored in the target volume (No in S3), the control server causes the process to proceed to S6.

If the control server determines that old data is already stored in the target volume (Yes in S3), the control server determines whether the data of the target volume is present in a disk array (S4). If the control server determines that the data of the target volume is present in the disk array (Yes in S4), the control server causes the process to proceed to S6.

If the control server determines that the data of the target volume is not present in the disk array (No in S4), the control server reads out, from a physical tape, the data of the target volume and loads (recalls) the data in the disk array (S5). After that, the control server causes the process to proceed to S6.

In S6, the control server notifies the host apparatus that mounting has been completed (S6). The control server then receives any of various commands from the host apparatus (S7) and determines whether the command received in S7 is an UNLOAD command (S8).

If the control server determines that the command received in S7 is not an UNLOAD command (No in S8), the control server determines whether the command received in S7 is a WRITE command (S9). If the control server determines that the command received in S7 is a WRITE command (Yes in S9), the control server starts to write data starting from the current block (S10). The control server then returns the process to S7.

If the control server determines that the command received in S7 is not a WRITE command (No in S9), the control server determines whether the command received in S7 is a READ command (S11). If the control server determines that the command received in S7 is a READ command (Yes in S11), the control server starts to read data starting from the current block, and sends the read-out data to the host apparatus (S12). The “current block” in S10 and S12 is, for example, a block on a virtual medium storing therein data of the target volume and the head of the logical drive is positioned at the block. Then, the control server returns the process to S7.

If the control server determines that the command received in S7 is not a READ command (No in S11), the control server determines whether the command received in S7 is a move command (S13). Examples of move commands include a SPACE command and a LOCATE command. These move commands virtually move, for example, the head of the logical drive to a predetermined position on a virtual medium storing therein data of the target volume. If the control server determines that the command received in S7 is a move command (Yes in S13), the control server performs processing to move the head to a specified block (S14), after which the control server returns the process to S7. If the control server determines that the command received in S7 is not a move command (No in S13), the control server returns the process to S7.

If the control server determines in S8 that the command received in S7 is an UNLOAD command (Yes in S8), the control server unloads a logical volume, and copies (migrates) the written data to a physical tape (S15). This terminates the process.

In the existing virtual tape system, if the size of the logical volume to be mounted is large, much time is taken in recall processing in S5 illustrated in FIG. 2. If the command received in S7 is a WRITE command, new data is written in S10, in spite of a recall being made in S5, to an area in the disk array in which the recalled logical volume data is stored. In this case, the recall processing itself goes to waste.

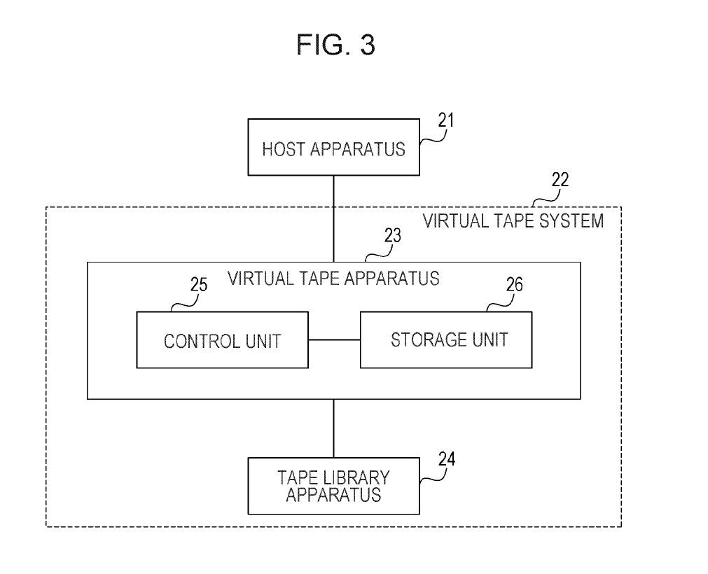

FIG. 3 illustrates an exemplary configuration of a virtual tape system according to an embodiment.

The host apparatus 21 in FIG. 3 is an information processing apparatus that sends a MOUNT instruction, a WRITE instruction, a READ instruction, and a move instruction to a virtual tape system 22. The MOUNT instruction includes information that identifies a logical volume to be mounted. The WRITE instruction includes data to be written and information that identifies a logical volume to which the data is to be written. The READ instruction includes information that identifies a logical volume from which data is to be read out. The move instruction includes information that identifies a logical volume to be moved and also includes information that identifies a destination block or information indicating the number of tape marks.

The virtual tape system 22 receives any of various instructions from the host apparatus 21, performs processing in response to the received instruction, and returns a processing result to the host apparatus 21. The virtual tape system 22 includes a virtual tape apparatus 23 and a tape library apparatus 24. The virtual tape apparatus 23 includes a control unit 25 that performs various types of control for the virtual tape apparatus 23 and also includes a storage unit 26 that stores therein data. The control unit 25 is, for example, an information processing apparatus. The storage unit 26 is, for example, a disk array apparatus in which a plurality of hard disk drives (magnetic disk units) are mounted and handled as a large-capacity disk. The tape library apparatus 24 includes at least one tape drive and a plurality of slots in which tape cartridges are inserted. The tape library apparatus 24 has functions of writing data to and reading data from a tape cartridge set in the tape drive and of replacing the set tape cartridge.

The virtual tape apparatus 23 is connected to the host apparatus 21 at a front end and is connected to the tape library apparatus 24 at a back end. The virtual tape apparatus 23 and host apparatus 21 are interconnected through, for example, a communication network. The virtual tape apparatus 23 and tape library apparatus 24 are also interconnected through, for example, a communication network. The control unit 25 and storage unit 26 are interconnected through, for example, a communication network or a bus.

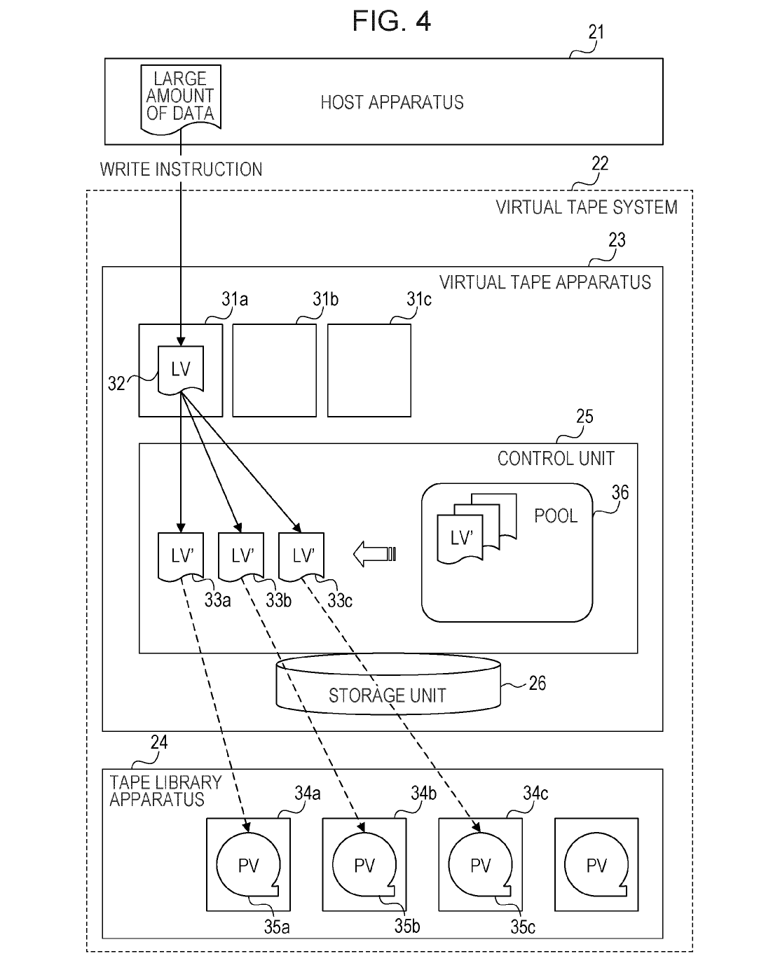

Next, write processing performed by the virtual tape system 22 according to an embodiment will be described. FIG. 4 illustrates write processing performed by the virtual tape system 22 according to the embodiment.

In FIG. 4, the host apparatus 21 sends, to the virtual tape system 22, a WRITE instruction to write a large amount of WRITE data into a logical volume 32. The host apparatus 21 recognizes logical drives 31 (31a to 31c) and the logical volume 32 in the virtual tape system 22. Upon receipt of the WRITE instruction from the host apparatus 21, the virtual tape apparatus 23 in the virtual tape system 22 divides the received logical volume 32 including large-sized data into a plurality of divided volumes 33 (33a to 33c). The divided volumes are internal logical volumes obtained by dividing the logical volume 32. The virtual tape apparatus 23 manages a set of not-yet-assigned divided volumes as a pool 36 and assigns a desirable number of divided volumes to the logical volume 32 from the pool 36. This dividing processing is not recognized by the host apparatus 21. Using physical drives 34 (34a to 34c) in the tape library apparatus 24, the virtual tape apparatus 23 concurrently stores the plurality of divided volumes 33 in the physical volumes 35 (35a to 35c). That is, the virtual tape apparatus 23 divides data of the large-sized logical volume 32 into a plurality of divided data items and concurrently migrates these divided data items.

Since a plurality of divided volumes are concurrently stored in a plurality of physical volumes 35 as described above, a time taken for migration may be reduced when compared with a case in which data of one large-sized logical volume 32 is stored in one physical volume 35. In a case as well in which data is read from physical volumes 35, divided volumes may be concurrently read from a plurality of physical volumes 35, so a time taken for a recall may be reduced.

Next, mount processing performed by the virtual tape system 22 according to the embodiment will be described.

In mount processing, when a MOUNT instruction for a certain logical volume 32 is received from the host apparatus 21, data of the logical volume 32 is loaded in the storage unit 26. The mount processing is performed differently depending on whether the data of the target volume is already stored in the storage unit 26 at the time at which the MOUNT instruction is received. Therefore, upon receipt of a MOUNT instruction from the host apparatus 21, the control unit 25 first determines whether the target volume is present in the storage unit 26. In the embodiment, this determination is made as to whether at least a certain specific portion of data of the target volume, that is, certain specific divided volumes, are present in the storage unit 26, rather than as to whether all data of the target volume is present in the storage unit 26. The certain specific divided volumes are specifically a predetermined number of divided volumes starting from the beginning among the plurality of divided volumes of the target volume and the last divided volume thereof.

If the control unit 25 determines that the certain specific volumes are present in the storage unit 26, the control unit 25 determines that the mount processing has been completed and sends a notification indicating that mounting has been completed to the host apparatus 21. If the control unit 25 determines that the certain specific volumes are not present in the storage unit 26, the control unit 25 recalls the certain specific volumes. Upon completion of the recall, the control unit 25 determines that the mount processing has been completed and sends a notification indicating that mounting has been completed to the host apparatus 21.

As described above, when at least certain specific divided volumes of the target volume are present in the storage unit 26, the control unit 25 determines that mounting has been completed. That is, if data of the target volume is not on-cached in mount processing, the control unit 25 does not recall all data of the target volume but recalls only a certain specific portion of data, and determines that mounting has been completed. Thus, a time from when the control unit 25 receives a MOUNT instruction until the control unit 25 starts processing on a next command may be reduced. In the embodiment in which only a certain portion of the target volume is recalled in mount processing as described above, if a WRITE command is received after mounting has been completed, a time taken for a recall that would otherwise be performed in vain may be reduced. Specifically, in the virtual tape system 22 according to the embodiment, the total of a time taken in processing on the MOUNT instruction and a time taken in processing on the WRITE instruction may be reduced.

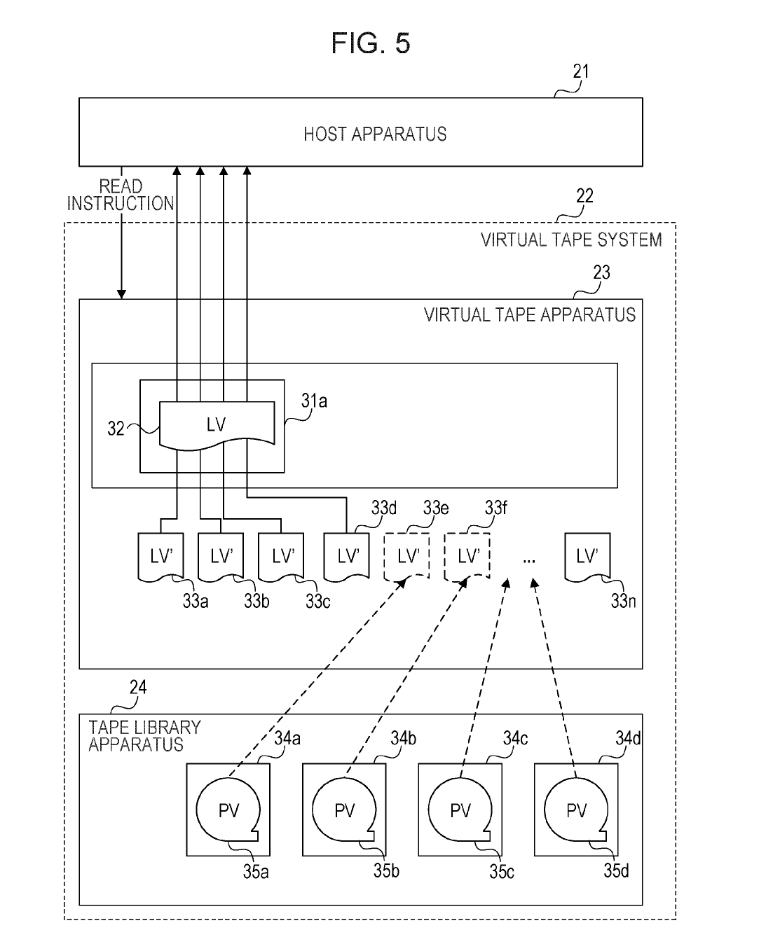

Next, read processing from the beginning of a target volume performed in the virtual tape system 22 according to the embodiment will be described. FIG. 5 illustrates read processing from the beginning of a target volume performed in the virtual tape system 22 according to the embodiment.

In the virtual tape system 22 according to the embodiment in FIG. 5, read processing from the beginning of a target volume is started after mount processing has been completed. Specifically, read processing is started in a state in which at least certain divided volumes 33 (33a to 33d and 33n) at the top and end of the target volume are present in the storage unit 26.

The host apparatus 21 sends, to the virtual tape system 22, a READ instruction to read data of a logical volume 32 from the beginning of the data. Upon receipt of the READ instruction from the host apparatus 21, the control unit 25 in the virtual tape system 22 reads out data of the logical volume 32 from the storage unit 26 and sends the read-out data to the host apparatus 21. In the embodiment, at least certain divided volumes 33 (33a to 33d and 33n) at the top and end of the target volume are present in the storage unit 26 at a time at which the read processing starts. Therefore, the control unit 25 first reads out data, starting from the first divided volume 33a, which is already stored in the storage unit 26, and sends the read-out data to the host apparatus 21. When reading data from the storage unit 26 and sending the read-out data to the host apparatus 21 is started, the control unit 25 concurrently recalls, by using the physical drives 34a to 34d, a plurality of not-yet-loaded divided volumes 33e, 33f, . . . from the physical volumes 35a to 35d. While performing the recall, the control unit 25 sequentially reads out data of the divided volumes 33 (33e, 33f, . . . ), which have been loaded by the recall, from the storage unit 26 and sends the read-out data to the host apparatus 21. Since the processing to read out data from the storage unit 26 and send the read-out data are concurrently performed with the recall processing as described above, the total of a time taken in processing on the MOUNT instruction and a time taken in processing on the READ instruction may be reduced. In read processing as well, the host apparatus 21 recognizes that data is read from the logical volume 32 by using a logical drive 31a.

In the description below, to distinguish between the reading out of data from a physical volume 35 and the reading out of data from the storage unit 26, the reading out of data from the physical volume 35 (including the storing of data in the storage unit 26) will be referred to “recall” and the reading out of data from the storage unit 26 will be referred to “reading”.

Next, processing on a move command performed by the virtual tape system 22 according to the embodiment will be described. A move command is an instruction to virtually move the head of a logical drive 31 recognized by the host apparatus 21 to a predetermined position on a virtual medium storing therein data of the logical volume 32. Move commands include a command that includes block identification information as information that specifies a movement destination and a command that includes the number of tape marks.

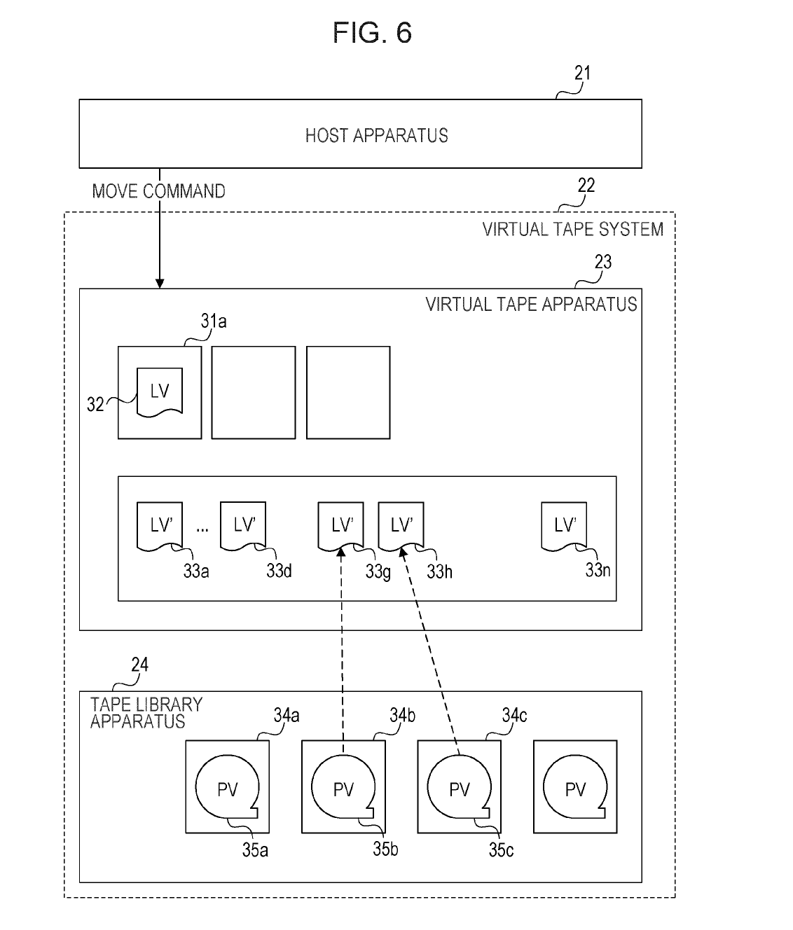

FIG. 6 illustrates processing on a move command performed in the virtual tape system 22 according to the embodiment. In the virtual tape system 22 in FIG. 6, processing on a move command is started after mount processing has been completed. That is, processing on a move command is started in a state in which at least certain divided volumes 33 (33a to 33d and 33n) at the top and end of the target volume are present in the storage unit 26.

The host apparatus 21 sends a move command to the virtual tape system 22. In the example in FIG. 6, a destination block specified by the move command is included in a divided volume 33g. Upon receipt of the move command from the host apparatus 21, the control unit 25 in the virtual tape system 22 determines whether data of the destination block specified by the move command is present in the storage unit 26. If the destination block is not present in the storage unit 26, the control unit 25 recalls a target divided volume that includes the destination block and a predetermined number of divided volumes following the target divided volume. In the example in FIG. 6, the divided volume 33g and a divided volume 33h, which follows the divided volume 33g, are recalled. The control unit 25 then sends a notification indicating that processing of the move command has been completed to the host apparatus 21. In this processing on the move command, a recall is not performed for divided volumes from a divided volume following the divided volume 33d, which has been recalled at the time of mounting, to a divided volume immediately before the divided volume 33g that includes the destination block.

As described above, in the virtual tape system 22 according to the embodiment, only a target divided volume that includes the destination block and a predetermined number of divided volumes following the target divided volume are recalled, and divided volumes before the target divided volume are not recalled. Thus, the total of a time taken in processing on the MOUNT instruction and a time taken in processing on the move command may be reduced.

Next, read processing after the execution of a move command performed in the virtual tape system 22 according to the embodiment will be described.

In the virtual tape system 22 according to the embodiment, read processing after the execution of a move command is started after processing on the move command has been completed. That is, read processing is started in a state in which, with respect to the target volume, at least the target divided volume that includes the destination block and a predetermined number of divided volumes following the target divided volume are present in the storage unit 26.

When the control unit 25 receives, from the host apparatus 21, a READ instruction after the execution of a move command, the control unit 25 in the virtual tape system 22 reads out data of the logical volume 32 from the storage unit 26 and transmits the read-out data to the host apparatus 21. In the embodiment, at least the target divided volume that includes the destination block and a predetermined number of divided volumes following the target divided volume are present in the storage unit 26 at a time at which the read processing starts. Therefore, the control unit 25 first reads out data, starting from the destination block, which is already stored in the storage unit 26, and sends the read-out data to the host apparatus 21. When reading data from the storage unit 26 and sending the read-out data to the host apparatus 21 is started, the control unit 25 concurrently recalls a plurality of not-yet-loaded divided volumes from physical volumes 35. While performing the recall, the control unit 25 sequentially reads out data of the divided volumes, which have been loaded by the recall, from the storage unit 26 and sends the read-out data to the host apparatus 21. Since the processing to read out data from the storage unit 26 and send the read-out data are concurrently performed with the recall processing as described above, the total of a time taken in processing on the MOUNT instruction and a time taken in processing on the READ instruction may be reduced.

Next, off-cache processing performed in the virtual tape system 22 according to the embodiment will be described.

If the area in the storage unit 26 is fully filled with written data received from the host apparatus 21, certain data in the storage unit 26 is deleted, by off-cache processing, to reserve an area to which new data may be written. According to the embodiment, the data to be deleted in off-cache processing is data that has been migrated and the last access time of which is oldest among the data in the storage unit 26.

Off-cache processing is performed in a case in which, for example, it is determined before a recall that, in the storage unit 26, there is no free space in which data read out from a tape is to be stored. That is, before performing a recall, the control unit 25 determines whether there is a free space, in the storage unit 26, the size of which is equal to or larger than the size of data to be recalled. If such a free space does not exist in the storage unit 26, the control unit 25 deletes data stored in the storage unit 26 until a free space equal to or larger than the size of data to be recalled is reserved.

In the existing virtual tape system, data is deleted in units of logical volumes 32. If, for example, a large-sized logical volume 32 is selected as a target to be off-cached, all data of the large-sized logical volume 32 is deleted from the storage unit 26 at a time. In the virtual tape system 22 according to the embodiment, however, data is deleted in units of divided volumes. If a free space equal to or larger than the size of data to be recalled may be reserved by, for example, deleting some of a plurality of divided volumes from the storage unit 26, no more divided volumes are off-cached. Thus, part of the logical volume 32 may be kept on-cached as much as possible. As a result, a time taken for a recall may be reduced.

In the virtual tape system 22 according to the embodiment, an order in which a plurality of divided volumes are deleted is controlled in accordance with respective locations of the divided volumes of the logical volume 32. Specifically, the control unit 25 controls the order in which divided volumes are deleted so that, among the plurality of divided volumes, a predetermined number of divided volumes starting from the beginning and the last divided volume are kept on-cached as much as possible. That is, the control unit 25 controls the order in which divided volumes are deleted so that divided volumes between a predetermined number of divided volumes starting from the beginning and the last divided volume are first off-cached. Thus, it is possible to place a predetermined number of divided volumes starting from the beginning and the last divided volume in the on-cached state for as many logical volumes 32 as possible. Therefore, the possibility may be increased that when a MOUNT instruction is received, these certain specific divided volumes are already stored in the storage unit 26. The predetermined number of divided volumes starting from the beginning and the last divided volume of the logical volume 32 are divided volumes for which a determination is made as to whether they have been mounted in mount processing according to the embodiment. In mount processing, the control unit 25 determines whether at least the predetermined number of divided volumes starting from the beginning and the last divided volume of the logical volume 32 are present in the storage unit 26. If these divided volumes are present in the storage unit 26, the control unit 25 determines that mounting has been completed. Therefore, when the predetermined number of divided volumes starting from the beginning and the last divided volume are kept on-cached for as many logical volumes 32 as possible, the possibility that a recall occurs in mount processing is reduced. Thus, in the entire system, it is possible to reduce a total time taken in mount processing performed in response to a plurality of mount requests.

The first divided volume includes data that is first accessed when reading or writing from the beginning of the logical volume is performed. The last divided volume includes data specified as a destination by a move command when data is additionally written to an existing logical volume from its end. Therefore, by keeping a predetermined number of divided volumes starting from the beginning and the last divided volume on-cached as much as possible, write processing, read processing, or move processing may be started earlier. Keeping data on-cached indicates keeping data in a state of stored in the storage unit 26.

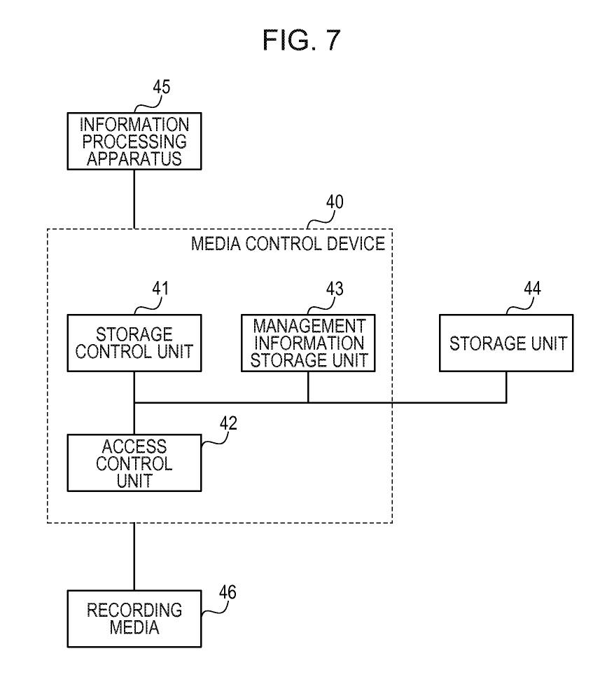

FIG. 7 illustrates an exemplary media control device 40 according to the embodiment. The media control device 40 includes a storage control unit 41, an access control unit 42, and a management information storage unit 43. The media control device 40 is connected to a storage unit 44, an information processing apparatus 45, and recording media 46 through a communication network or a bus. The control unit 25 is an example of the media control device 40. The storage unit 26 is an example of the storage unit 44. A tape cartridge in which the physical volume 35 in the tape library apparatus 24 is stored is an example of the recording media 46.

In response to a first request received from the information processing apparatus 45, the storage control unit 41 reads out any of a plurality of divided data items, which are obtained by dividing one set of data, from an intended recording medium of the recording media 46, in each of which one of the plurality of divided data items is stored, and stores the read-out divided data in the storage unit 44.

In response to a second request received from the information processing apparatus 45, the access control unit 42 accesses divided data stored in the storage unit 44.

The management information storage unit 43 stores therein management information that includes information in which the one set of data and the plurality of divided data items are mutually associated so as to be searchable.

The storage control unit 41 reads out any of a plurality of divided data items from one of the recording media 46 in accordance with the management information, and stores the read-out divided data in the storage unit 44.

Upon receipt of a WRITE request from the information processing apparatus 45, the storage control unit 41 creates a plurality of divided data items by dividing target WRITE data received from the information processing apparatus 45. The storage control unit 41 then stores, in the management information storage unit 43, the management information in which the target WRITE data and the plurality of divided data items are mutually associated so as to be searchable. The storage control unit 41 then concurrently stores the plurality of divided data items in the recording media 46.

In response to the first request, the storage control unit 41 reads out divided data that includes the block at the beginning of the one set of data from an intended recording medium of the recording media 46, and stores the read-out divided data in the storage unit 44. In response to an OVERWRITE request for overwriting from the beginning of the one set of data, the access control unit 42 performs overwrite processing on an area, in the storage unit 44, in which divided data that includes the block at the beginning of the one set of data is stored.

In response to the first request, the storage control unit 41 reads out divided data that includes the block at the beginning of the one set of data from an intended recording medium of the recording media 46, and stores the read-out divided data in the storage unit 44. In response to a request for reading from the beginning of the one set of data, the access control unit 42 reads out data from the block at the beginning of the divided data that includes the block at the beginning of the one set of data stored in the storage unit 44, and sends the read-out data to the information processing apparatus 45. In response to a READ request, the storage control unit 41 sequentially reads out, from the recording media 46, divided data next to divided data that includes data that is first read out by the access control unit 42 from the storage unit 44 and subsequent divided data items, and stores the read-out divided data items in the storage unit 44.

The management information includes information in which divided data is associated with control information such that the divided data is searchable. The control information indicates locations, on a virtual medium, at which the divided data is stored. When the storage control unit 41 receives, from the information processing apparatus 45, an access request that includes information indicating an access location, on a virtual medium, from which one set of data starts to be stored, the storage control unit 41 performs processing described below. That is, the storage control unit 41 reads out, from the recording media 46, divided data that includes data stored at the access location, and stores the read-out data in the storage unit 44.

If there is, in the storage unit 44, no free space in which divided data may be stored, the storage control unit 41 performs processing described below. That is, the storage control unit 41 sequentially deletes, from among a plurality of divided data items stored in the storage unit 44, divided data located between divided data that includes the block at the beginning of the one set of data and divided data that includes data at the end of the one set of data until intended divided data may be stored in the storage unit 44.

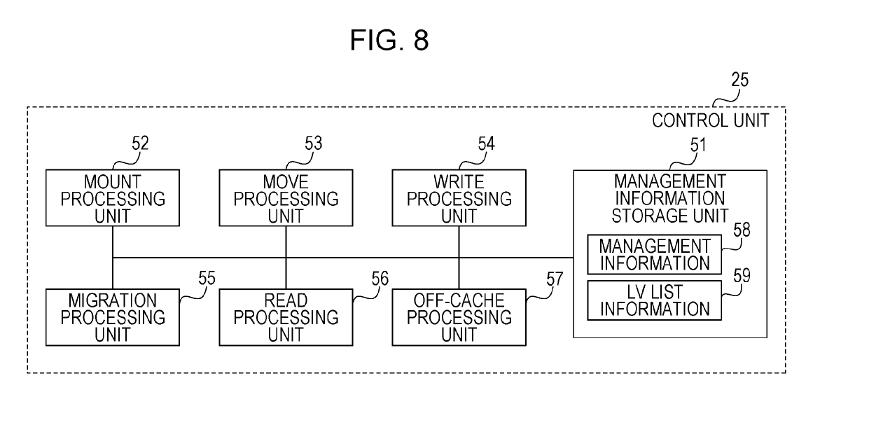

FIG. 8 illustrates an exemplary configuration of the control unit 25 according to an embodiment. The control unit 25 includes a management information storage unit 51, a mount processing unit 52, a move processing unit 53, a write processing unit 54, a migration processing unit 55, a read processing unit 56, and off-cache processing unit 57. The management information storage unit 51 is an example of the management information storage unit 43. The mount processing unit 52, move processing unit 53, migration processing unit 55, and off-cache processing unit 57 are each an example of the storage control unit 41. The write processing unit 54 and read processing unit 56 are each an example of the access control unit 42.

The management information storage unit 51 stores therein management information 58 and LV list information 59. The management information 58 associates information about the logical volume 32 with information about a plurality of divided volumes obtained by dividing the logical volume 32. The information about a divided volume includes a date and time at which the divided volume is last accessed, the range of blocks of data included in the divided volume, and the number of tape marks. The LV list information 59 is information about a list of logical volumes 32 managed by the virtual tape system 22. The LV list information 59 includes a date and time at which each logical volume 32 is last accessed and other information.

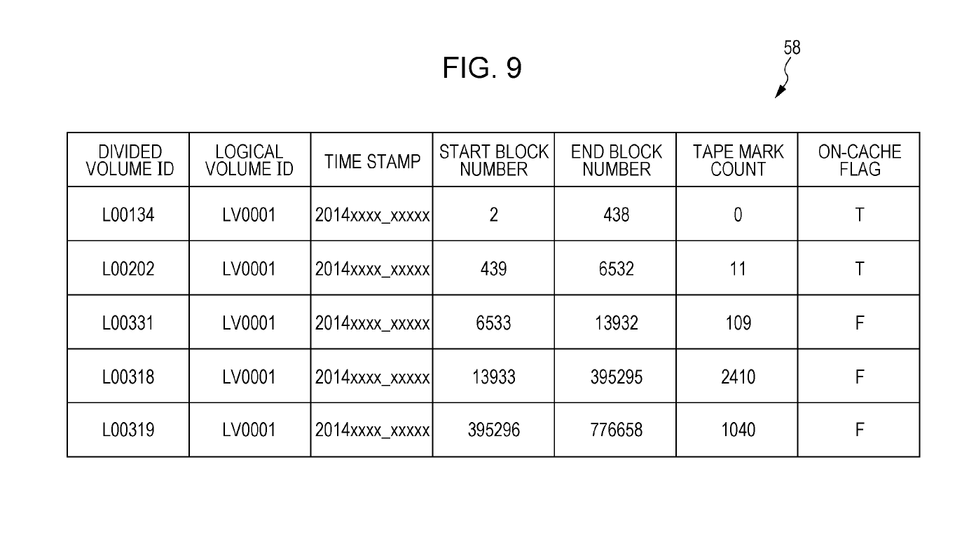

FIG. 9 illustrates an exemplary structure of the management information 58. The management information 58 includes data items of a “divided volume identifier (ID)”, a “logical volume ID”, a “time stamp”, a “start block number”, an “end block number”, a “tape mark count”, and an “on-cache flag”. Data in these data items of the management information 58 is stored in association with one another.

The “divided volume ID” is identification information that uniquely identifies a divided volume in the virtual tape system 22. The “logical volume ID” is information that uniquely identifies, in the virtual tape system 22, the logical volume 32 corresponding to the divided volume identified by the relevant divided volume ID. The “time stamp” is information that indicates a date and time at which the divided volume identified by the relevant divided volume ID is last accessed. The “start block number” is a start block number (information identifying the start block) of data included in the divided volume identified by the relevant divided volume ID. The “end block number” is an end block number (information identifying the end block) of data included in the divided volume identified by the relevant divided volume ID. The “tape mark count” is information that indicates the number of tape marks included in the divided volume identified by the relevant divided volume ID. The “on-cache flag” is information that indicates whether the divided volume identified by the relevant divided volume ID is on-cached.

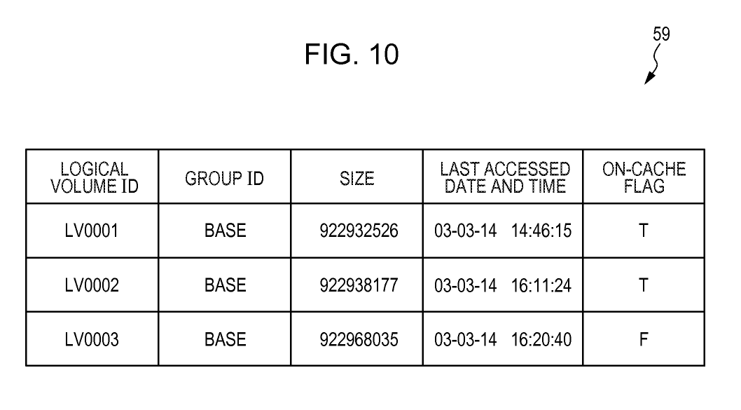

FIG. 10 illustrates an example of the LV list information 59. The LV list information 59 includes data items of a “logical volume ID”, a “group ID”, a “size”, a “last accessed date and time”, and an “on-cache flag”. Data in these data items in the LV list information 59 is stored in association with one another. The “logical volume ID” is information that uniquely identifies a logical volume 32 in the virtual tape system 22. The “group ID” is information that uniquely identifies, in the virtual tape system 22, a group that includes the logical volume 32 identified by the relevant “logical volume ID”. The “size” is information that indicates the size of the logical volume 32 identified by the relevant “logical volume ID”. The “last accessed date and time” is information that indicates a date and time at which the logical volume 32 identified by the relevant “logical volume ID” is last accessed. The “on-cache flag” is information that indicates whether the logical volume 32 identified by the relevant “logical volume ID” is on-cached. In the description below, when the “on-cache flag” in FIGS. 9 and 10 indicates “F” (False), it indicates that the volume is not on-cached (the volume is off-cached); when the “on-cache flag” indicates “T” (True), it indicates that the volume is on-cached. The “on-cache flag” in the LV list information 59 indicates a value indicating that the logical volume 32 is on-cached if certain divided volumes at the top and the end of the plurality of divided volumes of the logical volume 32.

When the mount processing unit 52 receives a MOUNT instruction to mount a specified logical volume 32 from the host apparatus 21, the mount processing unit 52 performs mount processing to load data of the specified logical volume 32 in the storage unit 26. In the mount processing, when the mount processing unit 52 receives a MOUNT instruction from the host apparatus 21, the mount processing unit 52 first determines whether the target volume is a new logical volume 32 or an existing logical volume 32. The mount processing unit 52 uses the management information 58 for this determination as to the target volume. Specifically, the mount processing unit 52 references a correspondence between the “divided volume ID” and the “logical volume ID” in the management information 58 to determine whether the logical volume 32 to be mounted is associated with a divided volume. If the mount processing unit 52 determines that the logical volume 32 to be mounted is associated with a divided volume, the mount processing unit 52 determines that the target volume is an existing logical volume 32. If the mount processing unit 52 determines that the logical volume 32 to be mounted is not associated with a divided volume, the mount processing unit 52 determines that the target volume is a new logical volume 32.

In a case in which the mount processing unit 52 determines that the target volume is a new logical volume 32, the mount processing unit 52 performs load processing for the new divided volume.

In the load processing for the new divided volume, the mount processing unit 52 first selects a not-yet-assigned divided volume from the pool 36 and assigns the selected divided volume to the logical volume 32. Specifically, the mount processing unit 52 stores identification information about the new logical volume 32 and identification information about the selected divided volume in the management information 58 in association with each other. That is, the mount processing unit 52 adds a new entry to the management information 58 and respectively stores the identification information about the selected divided volume and the identification information about the new logical volume 32 in the “divided volume ID” and “logical volume ID” in that entry. Although the size of the divided volume is assumed to have been preset, the size may be specified by the host apparatus 21 when the divided volume is assigned.

With respect to the pool 36, information used to manage not-yet-assigned divided volumes is stored. For example, identification information about not-yet-assigned divided volumes, their sizes, and other information are stored. In the embodiment, a set of not-yet-assigned divided volumes is described as the pool 36. A not-yet-assigned divided volume is a divided volume that is not yet assigned to any logical volume 32.

Upon completion of the processing to assign the divided volume to the logical volume 32, the mount processing unit 52 loads an area for the assigned divided volume in the storage unit 26. That is, the mount processing unit 52 reserves a free space with the size of the assigned divided volume in the storage unit 26.

If it is difficult to reserve a free space with the size of the assigned divided volume in the storage unit 26, the mount processing unit 52 outputs a request to perform off-cache processing to the off-cache processing unit 57. When the off-cache processing unit 57 receives the request to perform off-cache processing, the off-cache processing unit 57 performs off-caching to reserve a free space with the size of the divided volume in the storage unit 26. The off-cache processing unit 57 then sends the mount processing unit 52 a notification indicating that off-caching has been completed. Upon receipt of this notification, the mount processing unit 52 loads the assigned divided volume in the storage unit 26. In the load processing performed here, no data is stored in the divided volume, so an area with the size of the divided volume is reserved.

The mount processing unit 52 performs load processing for the new divided volume as described above. Upon completion of the load processing for the new divided volume, the mount processing unit 52 sends the host apparatus 21 a completion notification indicating that mounting has been completed. As described above, the mount processing unit 52 performs mount processing performed in a case in which the mount processing unit 52 determines that the target volume is a new logical volume 32. According to the embodiment, at a time at which a divided volume has been loaded in the storage unit 26, the control unit 25 (or, for example, a processor that executes certain software such as the operating system (OS) of the control unit 25) recognizes the loaded divided volume.

If the mount processing unit 52 determines that the target volume is an existing logical volume 32, the mount processing unit 52 determines whether certain specific divided volumes of a plurality of divided volumes of the target volume are present in the storage unit 26.

Specifically, the certain specific divided volumes are the first four divided volumes and the last divided volume of the plurality of divided volumes of the target volume. In the description below, divided volumes will be assumed to have been sequenced in ascending order of the IDs of the blocks at the beginnings of the respective divided volumes.

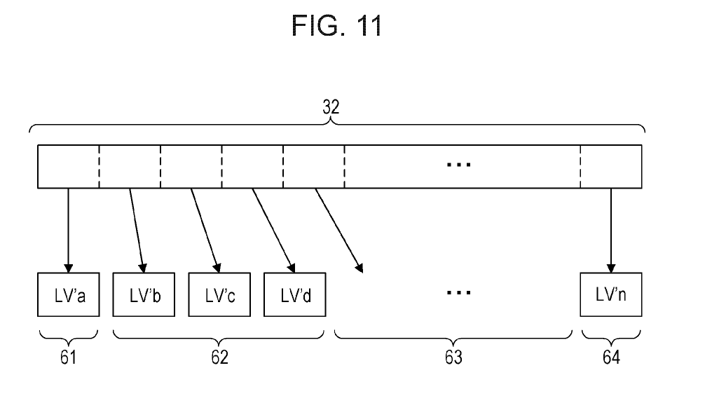

FIG. 11 illustrates a certain specific portion of data as to which a determination is made by the mount processing unit 52 as to whether certain specific divided volumes are present in the storage unit 26. In FIG. 11, a plurality of divided volumes obtained by dividing one logical volume 32 are classified into four types (divided volumes 61 to 64). The divided volume 61 is a divided volume at the beginning, which includes the block at the top of the logical volume 32. The divided volumes 62 are three divided volumes that follow the divided volume 61. The divided volume 64 is the divided volume at the end, which includes the block located at the end of the logical volume 32. The divided volumes 63 are data of the plurality of divided volumes of the logical volume 32 other than the divided volumes 61, 62, and 64, that is, divided volumes between the divided volumes 62 and the divided volume 64. Although, in the embodiment, the divided volumes 62 are three divided volumes that follow the divided volume 61, the number of divided volumes 62 is not limited to three; the divided volumes 62 may be any predetermined number of divided volumes.

The mount processing unit 52 determines whether data of at least the divided volumes 61, 62, and 64, which have been classified as in FIG. 11, is present in the storage unit 26. If the mount processing unit 52 determines that the divided volumes 61, 62, and 64 are all present in the storage unit 26, the mount processing unit 52 determines that the mounting has been completed and sends the host apparatus 21 a completion notification indicating that mounting has been completed. If the mount processing unit 52 determines that any of the divided volumes 61, 62, and 64 of the logical volume 32 is not present in the storage unit 26, the mount processing unit 52 recalls the divided volume of the divided volumes 61, 62, and 64, which is not present in the storage unit 26. When the recall has been completed and the divided volumes 61, 62, and 64 have been loaded in the storage unit 26, the mount processing unit 52 determines that the mounting has been completed and sends the host apparatus 21 a completion notification indicating that mounting has been completed.

That is, if the mount processing unit 52 receives a mount request when the divided volumes 61, 62, and 64 of the logical volume 32 to be mounted are all present in the storage unit 26, the mount processing unit 52 immediately notifies the host apparatus 21 that mounting has been completed. If the mount processing unit 52 receives a mount request when only the divided volumes 61 and 62 of the logical volume 32 to be mounted are on-cached, the mount processing unit 52 recalls the divided volume 64 and, after the recall has been completed, the mount processing unit 52 notifies the host apparatus 21 that mounting has been completed. If the mount processing unit 52 receives a mount request when only the divided volume 61 of the logical volume 32 to be mounted is on-cached, the mount processing unit 52 recalls the divided volumes 62 and 64 and, after the recall has been completed, the mount processing unit 52 notifies the host apparatus 21 that mounting has been completed. The divided volumes 62 and 64 are concurrently recalled by using a plurality of physical drives 34. If the mount processing unit 52 receives a mount request when there is no on-cached area of the logical volume 32 to be mounted, the mount processing unit 52 recalls the divided volumes 61, 62, and 64 and, after the recall has been completed, the mount processing unit 52 notifies the host apparatus 21 that mounting has been completed. The divided volumes 61, 62, and 64 are concurrently recalled by using a plurality of physical drives 34.

After a divided volume to be recalled is determined, the mount processing unit 52 determines whether there is, in the storage unit 26, a free space large enough to store the divided volume to be recalled, before the mount processing unit 52 actually performs a recall. If there is, in the storage unit 26, no free space large enough to store the divided volume to be recalled, the mount processing unit 52 outputs an off-cache request to the off-cache processing unit 57. Upon receipt the off-cache request, the off-cache processing unit 57 performs off-caching to reserve a free space with the size of the divided volume to be recalled in the storage unit 26. The off-cache processing unit 57 then notifies the mount processing unit 52 that off-caching has been completed. After being notified of this, the mount processing unit 52 recalls the divided volume in the reserved area.

In the embodiment, in the determination by the mount processing unit 52 as to whether a certain specific portion of data of the target volume is present in the storage unit 26, the certain specific portion of data has been the divided volumes 61, 62, and 64. However, embodiments are not limited to this; the certain specific portion of data may be any of the divided volumes 61, 62, and 64 or any combination thereof.

The move processing unit 53 receives a move command from the host apparatus 21 and executes the move command for a volume to be moved. The move command is executed after mount processing by the mount processing unit 52 has been completed.

With reference to the management information 58, the move processing unit 53 first identifies a divided volume that includes the destination block specified by the move command. Specifically, the move processing unit 53 references the “start block number”, “end block number”, or “tape mark count” in the management information 58 and identifies the divided volume that includes the destination block. The move processing unit 53 then determines whether the destination divided volume is on-cached, with reference to the management information 58. Specifically, the move processing unit 53 references the state of the “on-cache flag” in the management information 58 and determines whether the destination divided volume is on-cached. To determine whether the destination divided volume is on-cached, it may be determined whether the destination volume and a predetermined number of divided volumes that follow the destination volume are on-cached.

If the move processing unit 53 determines that the destination divided volume is not on-cached, the move processing unit 53 recalls the destination divided volume and the divided volume that follows destination divided volume. The divided volumes to be recalled may be the destination divided volume and a predetermined number of divided volumes that follow the destination divided volume. Upon completion of the recall, the move processing unit 53 performs processing to move the virtual head of the logical drive 31 to the location of the block to be moved. Then, the move processing unit 53 determines that move processing has been completed and sends the host apparatus 21 a movement completion notification indicating that move processing has been completed.

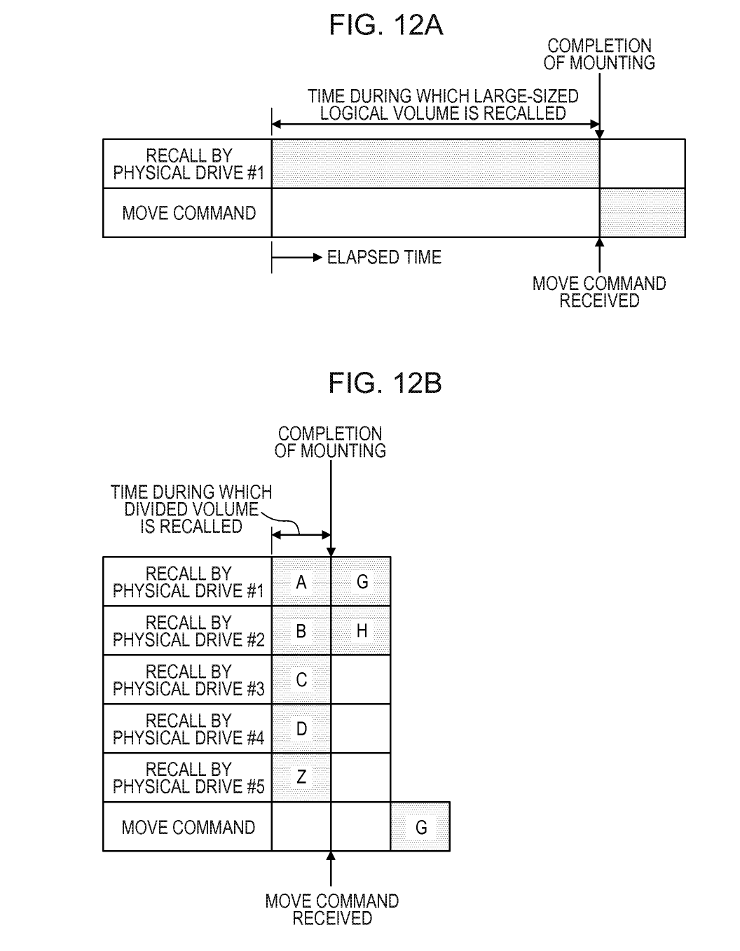

Now, reduction of time taken in processing of a move command in the virtual tape system 22 according to the embodiment will be described with reference to FIGS. 12A and 12B. FIG. 12A illustrates existing mount processing and time taken therein to process a move command. FIG. 12B illustrates mount processing in the virtual tape system 22 according to the embodiment and time taken therein to process a move command. FIGS. 12A and 12B each illustrate an example in which mount processing is performed in a state in which all divided volumes of the logical volume 32 to be moved are off-cached and then a move command is executed.

In the existing mount processing, all data of the logical volume 32 to be moved is recalled as illustrated in FIG. 12A. After the all data of the logical volume 32 has been recalled, move processing is started. The existing recall processing is performed by using a single physical drive 34 (physical drive #1).

In the embodiment, however, data of the divided volumes 61, 62, and 64 (A, B, C, D, and Z in FIG. 12B) is first recalled in mount processing, as illustrated in FIG. 12B. At a time at which these divided volumes have been completely recalled, a move command is executed. In the execution of the move command, a destination divided volume (G in the example in FIG. 12B) and a divided volume (H) that follows the destination divided volume (G) are recalled and move processing is then performed.

In the virtual tape system 22 according to the embodiment, time taken in mount processing and processing to execute a move command may be reduced when compared with the existing processing, as described above.

The write processing unit 54 receives a WRITE instruction from the host apparatus 21 and performs write processing in which the write processing unit 54 writes WRITE data to a target volume. Write processing by the write processing unit 54 is performed after mount processing by the mount processing unit 52 has been completed.

There are two types of WRITE instructions; a WRITE instruction for a new logical volume 32 and a WRITE instruction for an existing logical volume 32. In addition, there are two types of WRITE instructions for an existing logical volume 32; a WRITE instruction effective from the beginning of a logical volume 32 and a WRITE instruction effective from an intermediate point in a logical volume 32.

Write processing on a new logical volume 32 is started in a state in which an area for a newly assigned divided volume (referred to below as a divided volume LV′1, for explanation purposes) has been reserved in the storage unit 26.

In write processing on a new logical volume 32, the write processing unit 54 writes WRITE data to the newly assigned divided volume LV′1. If writing to the divided volume LV′1 proceeds and the divided volume LV′1 is fully filled with WRITE data before all WRITE data is written, the write processing unit 54 records information about the written data and identification information about the divided volume LV′1 in the management information 58 in association with each other. The information about the written data is specifically the range of the block IDs of data written to the divided volume and the number of tape marks in the data. Upon completion of the recording in the management information 58, the write processing unit 54 unmounts the divided volume LV′1 from the storage unit 26. When viewed from the host apparatus 21, to unmount the divided volume LV′1 is an operation that makes the control unit 25 (or, for example, a processor that executes certain software such as the OS of the control unit 25) unable to recognize the divided volume LV′1. The write processing unit 54 then outputs, to the migration processing unit 55, a request to perform migration of the unmounted divided volume LV′1.

In addition to outputting the migration request, the write processing unit 54 performs load processing for a new divided volume. This load processing for a new divided volume is similar to load processing performed by the mount processing unit 52 for a new divided volume. That is, the write processing unit 54 selects a new divided volume from the pool 36, updates the management information 58, and loads the selected divided volume.

The write processing unit 54 then resumes writing to the newly assigned divided volume (referred to below as a divided volume LV′2, for explanation purposes), starting from a block with a block ID next to the ID of the last block that has been written to the divided volume LV′1. If writing to the divided volume LV′2 proceeds and the divided volume LV′2 is fully filled with written data before all WRITE data is written, the write processing unit 54 performs similar processing on the divided volume LV′2 to that performed on the divided volume LV′1. The write processing unit 54 then performs load processing on the newly assigned divided volume again and repeats the processing similarly.

After having written all WRITE data, the write processing unit 54 terminates the write processing in response to the WRITE command. The write processing unit 54 also performs similar processing, to that performed on the divided volume LV′1, on a divided volume (referred to below as a divided volume LV′n, for explanation purposes) to which the last WRITE data has been written in the write processing. That is, the write processing unit 54 records information about the written data and identification information about the divided volume LV′n in the management information 58 in association with each other. The write processing unit 54 then unmounts the divided volume LV′n and outputs, to the migration processing unit 55, a request to perform migration of the unmounted divided volume LV′n.

There are two types of WRITE instructions for an existing logical volume 32; a WRITE instruction effective from the beginning of a logical volume 32 and an ADDITIONAL WRITE instruction effective from an intermediate point in a logical volume 32. An ADDITIONAL WRITE instruction effective from an intermediate point in a logical volume 32 is executed after processing on a move command has been completed.

Write processing performed on an existing logical volume 32 starting from the beginning of the logical volume 32 is started in a state in which at least certain divided volumes at the top and end of the target volume are present in the storage unit 26. This state is established by mount processing performed before the write processing. If the logical volume 32 fits to one divided volume, write processing is started in a state in which that divided volume is present in the storage unit 26.

The write processing unit 54 first writes WRITE data to the divided volume 61 at the beginning of the logical volume 32, which has been loaded in the storage unit 26. Furthermore, the write processing unit 54 performs processing to remove, from the management information 58, the correspondence between the logical volume 32 to be written and the divided volumes 62, 63, and 64. Specifically, the write processing unit 54 deletes entries corresponding to the divided volumes 62, 63, and 64 among the divided volumes associated with the logical volume 32 to be written, from the management information 58. The write processing unit 54 then initializes the divided volumes 62, 63, and 64 and returns the initialized divided volumes 62, 63, and 64 to the pool 36 as not-yet-assigned divided volumes.

If the divided volume 61 at the beginning is fully filled with written data before all WRITE data is written, the write processing unit 54 operates in a similar way to that for write processing on a new logical volume. That is, the write processing unit 54 records information about the written data and identification information about the divided volume 61 in the management information 58 in association with each other. The write processing unit 54 then unmounts the divided volume 61 from the storage unit 26 and outputs, to the migration processing unit 55, a request to perform migration of the unmounted divided volume 61. In addition to outputting the migration request, the write processing unit 54 performs load processing for a new divided volume. In the selection of a new divided volume from the pool 36 in the load processing of the new-volume, control may be performed so that a not-yet-assigned divided volume present on the disk is preferentially selected. The write processing unit 54 then resumes writing to the newly assigned divided volume, starting from a block with a block ID next to the ID of the last block that has been written. Subsequent operation of the write processing unit 54 is similar to that in write processing on a new divided volume.

If an initialized divided volume to be returned to the pool 36 is present in the storage unit 26, the data of the divided volume may be deleted from the storage unit 26 as well.

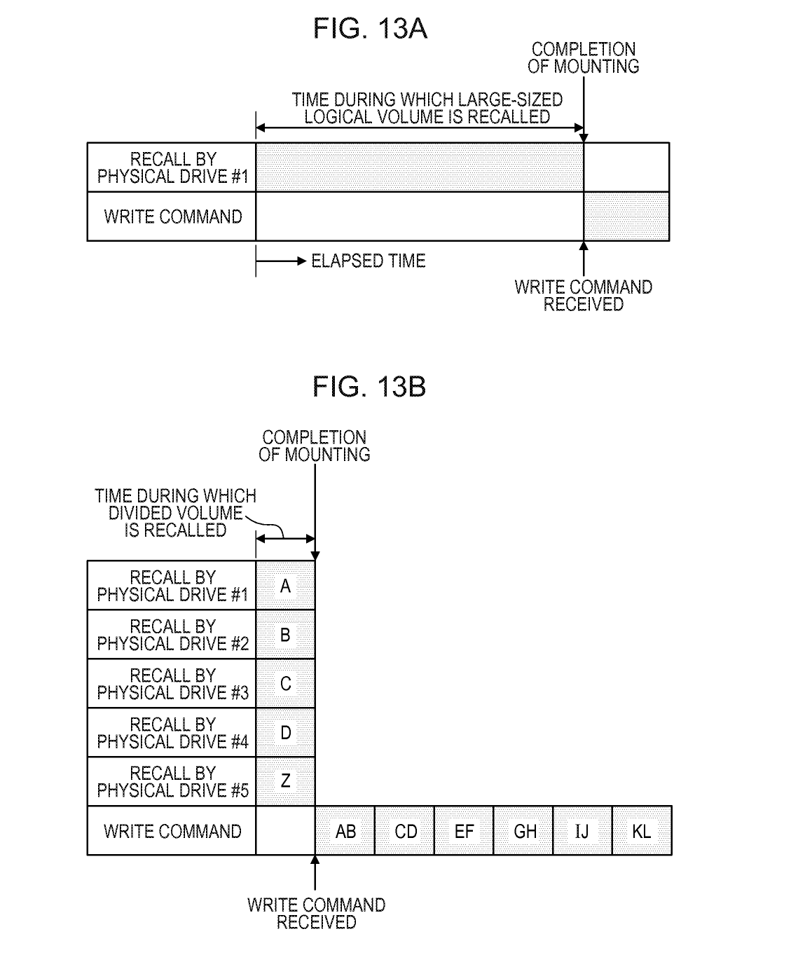

Now, reduction of time taken in write processing from the beginning of a logical volume 32 in the virtual tape system 22 according to the embodiment will be described with reference to FIGS. 13A and 13B. FIG. 13A illustrates existing mount processing and time taken therein in write processing from the beginning. FIG. 13B illustrates mount processing in the virtual tape system 22 according to the embodiment and time taken therein in write processing from the beginning. FIGS. 13A and 13B each illustrate an example in which mount processing is performed in a state in which all divided volumes of the logical volume 32 to be written are off-cached and then write processing is started.

In the existing mount processing, all data of the logical volume 32 to be written is recalled as illustrated in FIG. 13A. After the all data of the logical volume 32 has been recalled, write processing is started. The existing recall processing is performed by using a single physical drive 34 (physical drive #1).

In the virtual tape system 22 according to the embodiment, however, data of the divided volumes 61, 62, and 64 (A, B, C, D, and Z in FIG. 13B) is first recalled in mount processing, as illustrated in FIG. 13B. At a time at which these divided volumes have been completely recalled, write processing is started. Since the divided volumes 63 are not recalled as described above, time taken in mount processing and processing to execute a WRITE command may be reduced in the virtual tape system 22 according to the embodiment when compared with the existing processing.

Additional-write processing performed on an existing logical volume 32 starting from an intermediate point in a logical volume 32 is performed after the execution of a move command has been completed. Therefore, additional-write processing is started in a state in which at least a divided volume that includes a destination block and a predetermined number of divided volumes following that divided volume are present in the storage unit 26. If the logical volume 32 fits to one divided volume, additional-write processing is started in a state in which that divided volume is present in the storage unit 26.

The write processing unit 54 first writes WRITE data to a divided volume (referred to below as the divided volume LV′m, for explanation purposes) to which the head has been moved and which has been loaded in the storage unit 26. Furthermore, the write processing unit 54 removes the correspondence between the logical volume 32 to be written and divided volumes that follow the divided volume LV′m. Specifically, the write processing unit 54 deletes, from the management information 58, entries of the divided volumes that follow the divided volume LV′m among the divided volumes associated with the logical volume 32. The write processing unit 54 then initializes the divided volumes that follow the divided volume LV′m and returns the initialized divided volumes to the pool 36. Subsequent operation of the write processing unit 54 is similar to that in the write processing from the beginning of an existing logical volume 32.

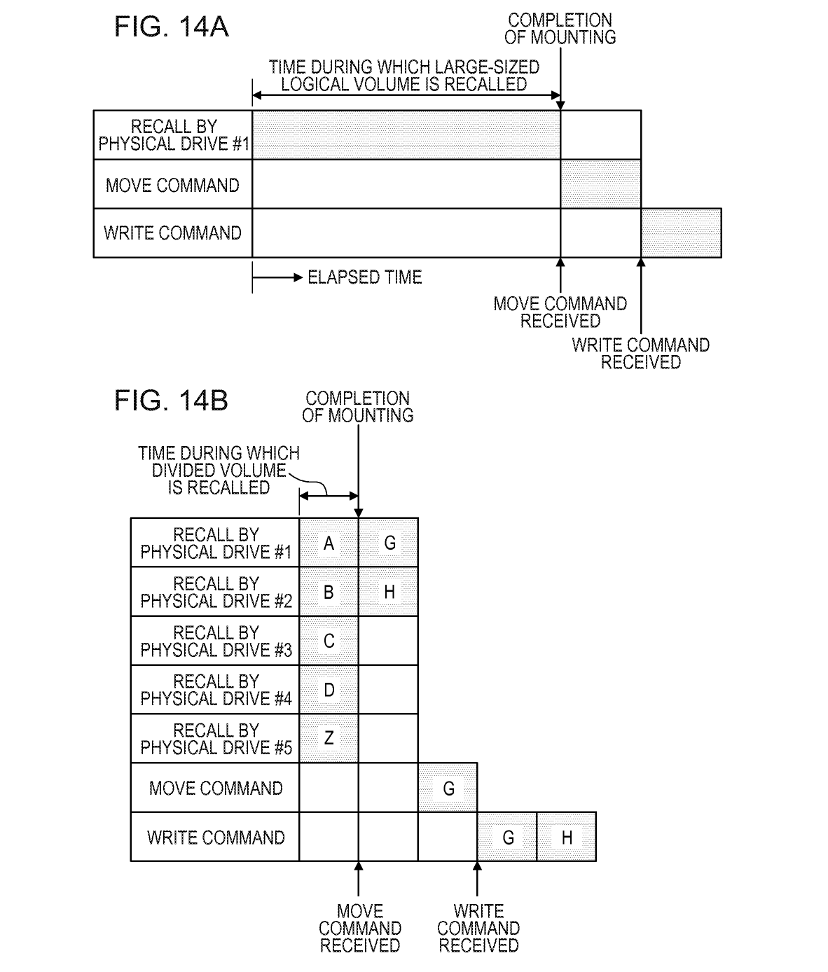

Now, reduction of time taken in additional-write processing from an intermediate point in a logical volume 32 in the virtual tape system 22 according to the embodiment will be described with reference to FIGS. 14A and 14B. FIG. 14A illustrates existing mount processing and time taken therein in additional-write processing from an intermediate point in a logical volume 32. FIG. 14B illustrates mount processing in the virtual tape system 22 according to the embodiment and time taken therein in additional-write processing from an intermediate point in a logical volume 32. FIGS. 14A and 14B each illustrate an example in which mount processing is performed in a state in which all divided volumes of the logical volume 32 to be written are off-cached, move processing is performed, and then write processing is started.

In the existing mount processing, all data of the logical volume 32 to be written is recalled as illustrated in FIG. 14A. After the all data of the logical volume 32 has been recalled, move processing is started. Upon completion of the move processing, write processing is started. The existing recall processing is performed by using a single physical drive 34 (physical drive #1).

In the embodiment, however, data of the divided volumes 61, 62, and 64 (A, B, C, D, and Z in FIG. 14B) is first recalled in mount processing, as illustrated in FIG. 14B. At a time at which these divided volumes have been completely recalled, a move command is executed. In the execution of the move command, a destination divided volume (G) and a divided volume (H) that follows the destination divided volume (G) are recalled and move processing is then performed. Upon completion of the move processing, write processing is started.

As described above, in the virtual tape system 22 according to the embodiment, time taken in mount processing, processing to execute a move command, and processing to execute a WRITE command may be reduced when compared with the existing processing.

The migration processing unit 55 performs migration of divided volumes. Migration of divided volumes is performed at a time at which the migration processing unit 55 receives a request to perform migration of divided volumes from the write processing unit 54.

In migration processing, the migration processing unit 55 stores data of the divided volumes, which is stored in the storage unit 26, in the physical volume 35 created in a tape cartridge in the tape library apparatus 24. Before migration processing is performed, as many physical volumes 35 as the number of physical drives 34 in the tape library apparatus 24 are created in advance. These physical volumes 35 correspond to physical drives 34 on a one-to-one basis, and data is written to and read from each physical volume 35 by using its corresponding physical drive 34. Since physical volumes 35 used as destinations in migration correspond to physical drives 34 in the tape library apparatus 24 on a one-to-one basis as described above, data of the physical volumes 35 may be concurrently accessed when the data is migrated or recalled.

In migration of divided volumes, the migration processing unit 55 uses physical drives 34 in rotation. If N physical drives 34 are included in the tape library apparatus 24, for example, the migration processing unit 55 controls these physical drives 34 so that after a physical drive 34 (physical drive #1) has been used in migration, a physical drive 34 (physical drive #2) is then used. After physical drives 34 (physical drive #3, #4, . . . , #N) have been used, the physical drive 34 (physical drive #1) is used again. Write processing by a plurality of physical drives 34 on their corresponding physical volumes 35 may be concurrently performed.

Since physical volumes 35 and physical drives 34 are mutually associated on a one-to-one basis and data of the divided volumes is sequentially stored in the physical volumes 35 as described above, data of a plurality of divided volumes corresponding to one logical volume 32 may be concurrently read out and written as much as possible. If all divided volumes have the same size, variations in migration performance for each divided volume may be reduced, suppressing a particular divided volume from becoming a bottleneck in the reading or writing of the particular divided volume.

The read processing unit 56 receives a READ instruction from the host apparatus 21, reads out target data from a target logical volume 32, and sends the read-out data to the host apparatus 21. Read processing by the read processing unit 56 is performed after mount processing by the mount processing unit 52 has been completed.

There are two types of READ instructions; a READ instruction effective from the beginning of a logical volume 32 and a READ instruction effective from an intermediate point in a logical volume 32. The READ instruction effective from an intermediate point in a logical volume 32 is a READ instruction processed after a move command has been executed.

Read processing performed from the beginning of a logical volume 32 is started in a state in which at least certain divided volumes at the top and end of the target volume are present in the storage unit 26. This state is established by mount processing performed before the read processing. If the logical volume 32 fits to one divided volume, read processing is started in a state in which that divided volume is present in the storage unit 26.

The read processing unit 56 first starts to read out data from the first divided volume 61 already stored in the storage unit 26 and sends the read-out data to the host apparatus 21. If there are off-cached divided volumes, in addition to starting the reading data from the storage unit 26 and sending the read-out data to the host apparatus 21, the read processing unit 56 recalls the off-cached divided volumes from the physical volume 35 sequentially starting from the divided volume at the beginning of the off-cached divided volumes. While performing a recall, the read processing unit 56 sequentially reads out, from the storage unit 26, data of the divided volumes that has been recalled and sends the read-out data to the host apparatus 21. That is, the read processing unit 56 concurrently performs recall processing and processing to read out data from the storage unit 26 and send the read-out data. If the reading out of data from the storage unit 26 proceeds faster than the recall, there may be, in the processing to read out data from the storage unit 26, a case in which no more data to be read is present in the storage unit 26. In this case, the read processing unit 56 sends a retry request for a READ command to the host apparatus 21.

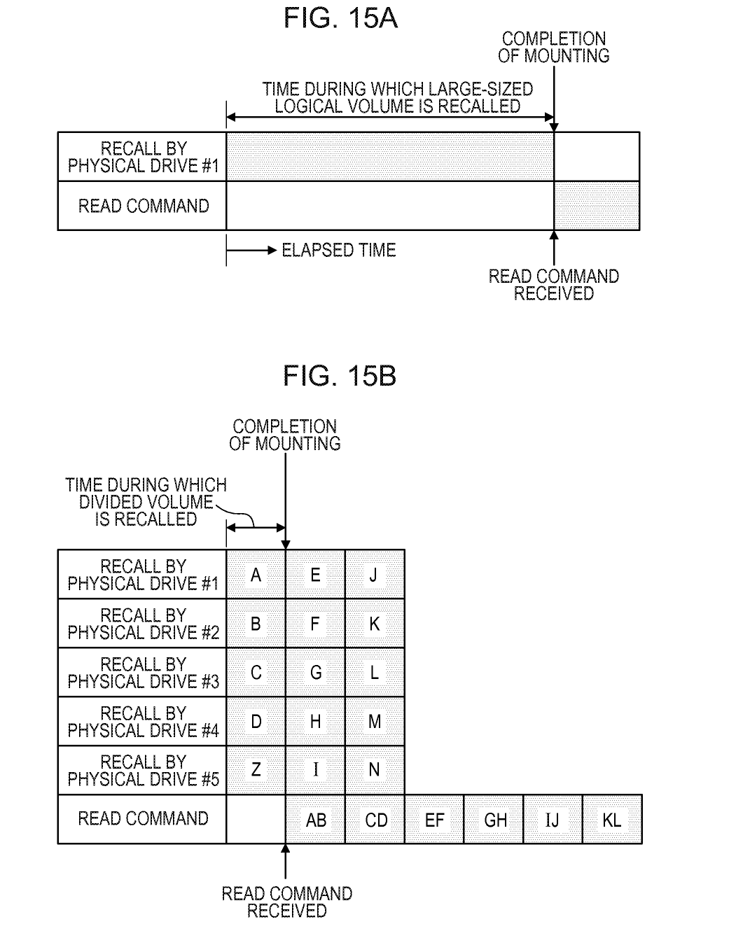

Now, reduction of time taken in read processing from the beginning of a logical volume 32 in the virtual tape system 22 according to the embodiment will be described with reference to FIGS. 15A and 15B. FIG. 15A illustrates existing mount processing and time taken therein in read processing from the beginning. FIG. 15B illustrates mount processing in the virtual tape system 22 according to the embodiment and time taken therein in read processing from the beginning. FIGS. 15A and 15B each illustrate an example in which mount processing is performed in a state in which all divided volumes of the logical volume 32 to be read out are off-cached and then write processing is started.

In the existing mount processing, all data of the logical volume 32 to be read out is recalled as illustrated in FIG. 15A. After the all data of the logical volume 32 has been recalled, read processing is started. The existing recall processing is performed by using a single physical drive 34 (physical drive #1).

In the virtual tape system 22 according to the embodiment, however, data of the divided volumes 61, 62, and 64 (A, B, C, D, and Z in FIG. 15B) is first recalled in mount processing, as illustrated in FIG. 15B. At a time at which these divided volumes have been completely recalled, read processing is started. In parallel to the read processing, divided volumes yet to be recalled are recalled. In this recall processing, a plurality of physical drives 34 concurrently recall divided volumes. Accordingly, in the virtual tape system 22 according to the embodiment, time taken in mount processing and processing to execute a READ command may be reduced when compared with the existing processing.

Read processing starting from an intermediate point in a logical volume 32 is performed after the execution of a move command has been completed. Therefore, the read processing is started in a state in which at least a divided volume that includes a destination block and a predetermined number of divided volumes following that divided volume are present in the storage unit 26. If the logical volume 32 fits to one divided volume, the read processing is started in a state in which that divided volume is present in the storage unit 26.

The read processing unit 56 first starts to read out data from a divided volume LV′m that has been loaded in the storage unit 26, and sends the read-out data to the host apparatus 21. If there is off-cached divided volumes among the divided volumes that follow the divided volume LV′m, in addition to starting to read out data from the storage unit 26 and sending the read-out data to the host apparatus 21, the read processing unit 56 recalls, from the physical volume 35, one or more off-cached divided volumes among the divided volumes that follow the divided volume LV′m, sequentially starting from the divided volume at the beginning of the divided volumes to be recalled. While performing a recall, the read processing unit 56 sequentially reads out, from the storage unit 26, data of the divided volumes that have been loaded by being recalled and sends the read-out data to the host apparatus 21. That is, the read processing unit 56 concurrently performs recall processing and processing to read out data from the storage unit 26 and send the read-out data. If the reading out of data from the storage unit 26 proceeds faster than the recall, there may be, in the processing to read out data from the storage unit 26, a case in which no more data to be read out is present in the storage unit 26. In this case, the read processing unit 56 sends a retry request for a READ command to the host apparatus 21.

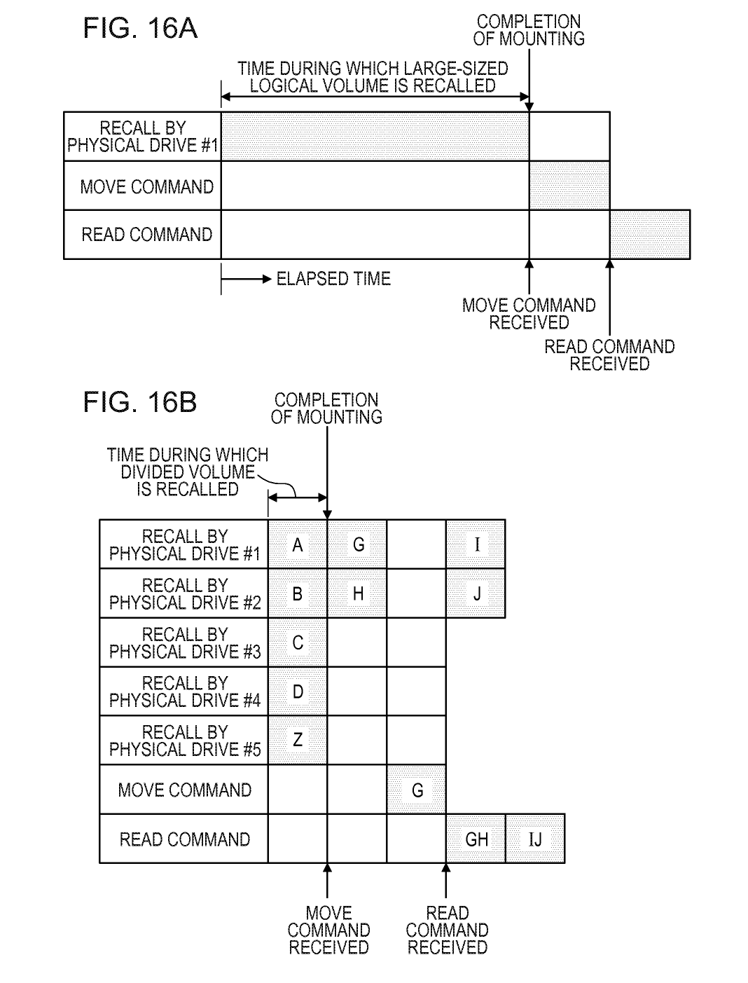

Now, reduction of time taken in read processing from an intermediate point in a logical volume 32 in the virtual tape system 22 according to the embodiment will be described with reference to FIGS. 16A and 16B. FIG. 16A illustrates existing mount processing and time taken therein in read processing from an intermediate point in a logical volume 32. FIG. 16B illustrates mount processing in the virtual tape system 22 according to the embodiment and time taken therein in read processing from an intermediate point in a logical volume 32. FIGS. 16A and 16B each illustrate an example in which mount processing is performed in a state in which all divided volumes of the logical volume 32 to be read out are off-cached, move processing is performed, and then read processing is started.

In the existing mount processing, after all data of the logical volume 32 to be read out has been completely recalled in mount processing, a move command is executed and read processing is started, as illustrated in FIG. 16A. The existing recall processing is performed by using a single physical drive 34 (physical drive #1).

In the embodiment, however, data of the divided volumes 61, 62, and 64 (A, B, C, D, and Z in FIG. 16B) is first recalled in mount processing, as illustrated in FIG. 16B. At a time at which these divided volumes have been completely recalled, a move command is executed. In the execution of the move command, a destination divided volume (G) and the divided volume (H) that follows the destination divided volume (G) are recalled and move processing is then performed. Upon completion of the move processing, read processing is started. In parallel to the read processing, divided volumes (I, J, . . . ) yet to be recalled are recalled. In this recall processing, a plurality of physical drives 34 concurrently recall divided volumes. Accordingly, in the virtual tape system 22 according to the embodiment, time taken in mount processing, processing to execute a move command, and processing to execute a READ command may be reduced when compared with the existing processing.

The off-cache processing unit 57 receives a request to perform off-cache processing and off-caches in units of divided volumes in response to the received request. The request to perform off-cache processing includes space size information that indicates the size of a free space to be reserved in the storage unit 26 by the off-cache. In the off-cache processing, the off-cache processing unit 57 controls an order in which divided volumes are off-cached. A plurality of divided volumes are each assigned with off-cache priority. The order in which divided volumes are off-cached is controlled in accordance with an order of the off-cache priority.

First, an operation to off-cache divided volumes of one logical volume 32 will be described. In this operation, an off-cache priority is assigned to each divided volume as described below. Specifically, if divided volumes are classified into four types as illustrated in FIG. 11, off-cache priorities are assigned so that divided volumes 63, 64, 62, and 61 have a high priority in that order. The off-cache processing unit 57 sequentially deletes divided volumes from the storage unit 26 according to the priorities assigned in this way until a free space with an adequate size may be reserved.

Specifically, the off-cache processing unit 57 first off-caches divided volumes 63, from among a plurality of divided volumes of a logical volume 32 to be off-cached, and checks the size of a free space. If the free space in the storage unit 26 is inadequate even after the divided volumes 63 have been off-cached, the off-cache processing unit 57 off-caches the divided volumes 64, 62, and 61 in that order; upon completion of each off-caching, the off-cache processing unit 57 checks the size of a free space. If the off-cache processing unit 57 may confirm that a free space with an adequate size has been reserved, the off-cache processing unit 57 stops subsequent off-caching. In the check of a free space, the off-cache processing unit 57 determines whether the size of the free space in the storage unit 26 is equal to or larger than the size indicated in the space size information.

Next, an operation to off-cache a plurality of divided volumes spanning a plurality of logical volumes 32 will be described.

When a plurality of divided volumes spanning a plurality of logical volumes 32 are off-cached, logical volumes 32 accessed last at a date and time earlier than a predetermined threshold (referred to below as a priority threshold) are first off-cached. If the size of the free space is inadequate even after these earlier accessed logical volumes 32 have been off-cached, logical volumes 32 accessed last at a date and time later than the priority threshold are off-cached. The priority threshold is a date and time based on which a priority in off-caching is set. The administrator of the virtual tape system 22 may set the priority threshold to a desired value.

Logical volumes 32 accessed last at a date and time earlier than the priority threshold will be referred to old logical volumes, and logical volumes 32 accessed last at a date and time later than the priority threshold will be referred to new logical volumes. Old logical volumes and new logical volumes are identified by referencing the “last accessed date and time” in the LV list information 59. To simplify the following description of the setting of a priority, priorities are higher in the order in which they are set. However, priorities may be set in any order as long as a relationship among priority values is the same as a result.

First, the off-cache processing unit 57 sets priorities for one or more old logical volumes. If only one old logical volume is present, the off-cache processing unit 57 sets priorities as in the operation to off-cache divided volumes in one logical volume 32. If a plurality of old logical volumes are present, the off-cache processing unit 57 assigns off-cache priorities for each type of divided volumes among a plurality of divided volumes of each old logical volume. Specifically, the off-cache processing unit 57 first assigns off-cache priorities to a plurality of divided volumes 63 of the plurality of old logical volumes, after which the off-cache processing unit 57 similarly assigns off-cache priorities to a plurality of divided volumes 64 of the plurality of old logical volumes and then assigns priorities to a plurality of divided volumes 62 and a plurality of divided volumes 61 of the plurality of old logical volumes in that order.

In the assignment of off-cache priorities for each type of divided volumes, the off-cache processing unit 57 assigns off-cache priorities so that a priority becomes higher as the date and time of last access becomes earlier. Specifically, the off-cache processing unit 57 first assigns off-cache priorities to the plurality of divided volumes 63 of the plurality of old logical volumes so that the earlier the last accessed date and time of the divided volume is, the higher the priority of the divided volume is. The off-cache processing unit 57 similarly assigns off-cache priorities to the plurality of divided volumes 64, 62, and 61 of the plurality of old logical volumes. That is, for each type of the plurality of divided volumes 64, 62, and 61, the off-cache processing unit 57 sequentially assign off-cache priorities so that the divided volume having the earliest last accessed date and time is assigned with the highest off-cache priority.

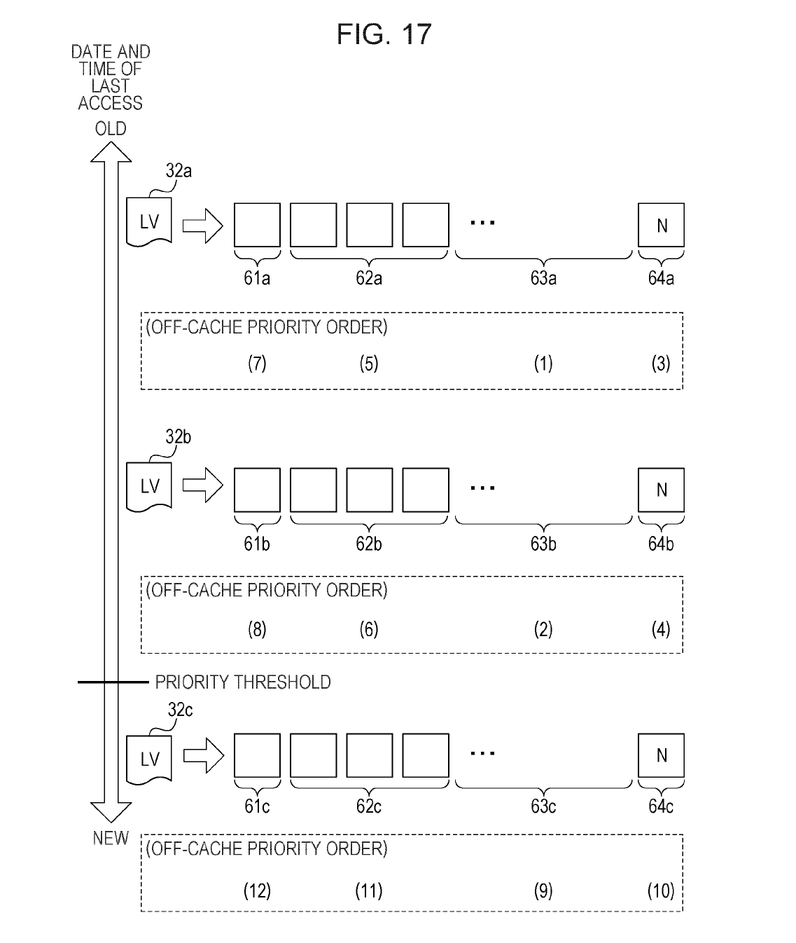

FIG. 17 illustrates an operation to off-cache a plurality of divided volumes of a plurality of logical volumes 32. The logical volumes 32a, 32b, and 32c in FIG. 17 are divided into a plurality of divided volumes. Last accessed dates and times of the logical volumes 32a, 32b, and 32c are earlier in that order. It is assumed that the last accessed dates and times of the logical volumes 32a and 32b are earlier than the priority threshold and that the last accessed date and time of the logical volume 32c is later than the priority threshold. That is, the logical volumes 32a and 32b are old logical volumes and the logical volume 32c is a new logical volume.

In this case, the off-cache processing unit 57 first assigns off-cache priorities to the divided volumes 63 of the logical volumes 32a and 32b, which are old logical volumes, sequentially starting from the logical volume 32 that has the earliest last accessed date and time. That is, the off-cache processing unit 57 assigns off-cache priorities so that the divided volumes 63a and 63b have a high priority in that order.

Next, the off-cache processing unit 57 assigns off-cache priorities to the divided volumes 64 of the logical volumes 32a and 32b, sequentially starting from the logical volume 32 that has the earliest last accessed date and time. That is, the off-cache processing unit 57 assigns off-cache priorities so that the divided volumes 64a and 64b have a high priority in that order.

Next, the off-cache processing unit 57 assigns off-cache priorities to the divided volumes 62 of the logical volumes 32a and 32b, sequentially starting from the logical volume 32 that has the earliest last accessed date and time. That is, the off-cache processing unit 57 assigns off-cache priorities so that the divided volumes 62a and 62b have a high priority in that order.

The off-cache processing unit 57 finally assigns off-cache priorities to the divided volumes 61 of the logical volumes 32a and 32b, sequentially starting from the logical volume 32 that has the earliest last accessed date and time. That is, the off-cache processing unit 57 assigns off-cache priorities so that the divided volumes 61a and 61b have a high priority in that order.

Upon completion of assignment of priorities to the old logical volumes, the off-cache processing unit 57 assigns priorities to the logical volume 32c, which is a new logical volume. Specifically, the off-cache processing unit 57 assigns priorities to the logical volume 32c so that the divided volumes 63c, 64c, 62c, and 61c have a high priority in that order.

As a result, priorities are assigned in the order indicated in the parenthesized numbers in FIG. 17. In FIG. 17, the priority indicated by the number “1” is the highest, and the priority indicated by the number “12” is the lowest.

After having assigned a priority to each divided volume, the off-cache processing unit 57 deletes divided volumes sequentially starting from the divided volume having the highest priority until a free space large enough for a recall may be reserved. At a point in time at which an adequate free space has been reserved, the off-cache processing unit 57 terminates the off-cache processing.

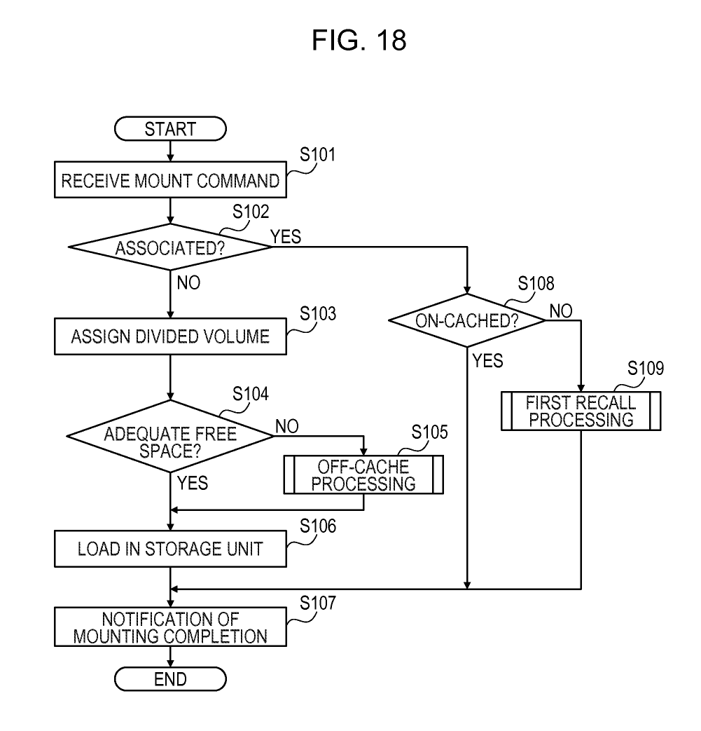

FIG. 18 is a flowchart illustrating details of mount processing performed by the mount processing unit 52 according to an embodiment.

In FIG. 18, the mount processing unit 52 first receives a MOUNT instruction from the host apparatus 21 (S101).

Next, the mount processing unit 52 references the management information 58 to determine whether a target logical volume to be mounted and divided volumes are mutually associated (S102). That is, the mount processing unit 52 determines whether the target logical volume is an existing logical volume 32 or a new logical volume 32. If the target logical volume to be mounted and divided volumes are mutually associated, the target logical volume is an existing logical volume. If the target logical volume to be mounted and divided volumes are not mutually associated, the target logical volume is a new logical volume. Specifically, the mount processing unit 52 extracts, from the management information 58, an entry in which the value of the “logical volume ID” matches information that identifies the target logical volume to be mounted and determines whether a value is set to the “divided volume ID” in the extracted entry. If a value is set to the “divided volume ID” in the extracted entry, the mount processing unit 52 determines that the target logical volume to be mounted and divided volumes are mutually associated. If a value is not set to the “divided volume ID” in the extracted entry, the mount processing unit 52 determines that the target logical volume to be mounted and divided volumes are not mutually associated.

If the mount processing unit 52 determines in S102 that the target logical volume to be mounted and divided volumes are not mutually associated (No in S102), the mount processing unit 52 selects a not-yet-assigned divided volume from the pool 36 and assigns the selected not-yet-assigned divided volume to the target logical volume (S103).

The mount processing unit 52 then determines whether the size of a free space in the storage unit 26 is equal to or larger than the size of the divided volume assigned in S103 (S104). This determination is made to determine whether the divided volume assigned in S103 may be loaded in the storage unit 26.

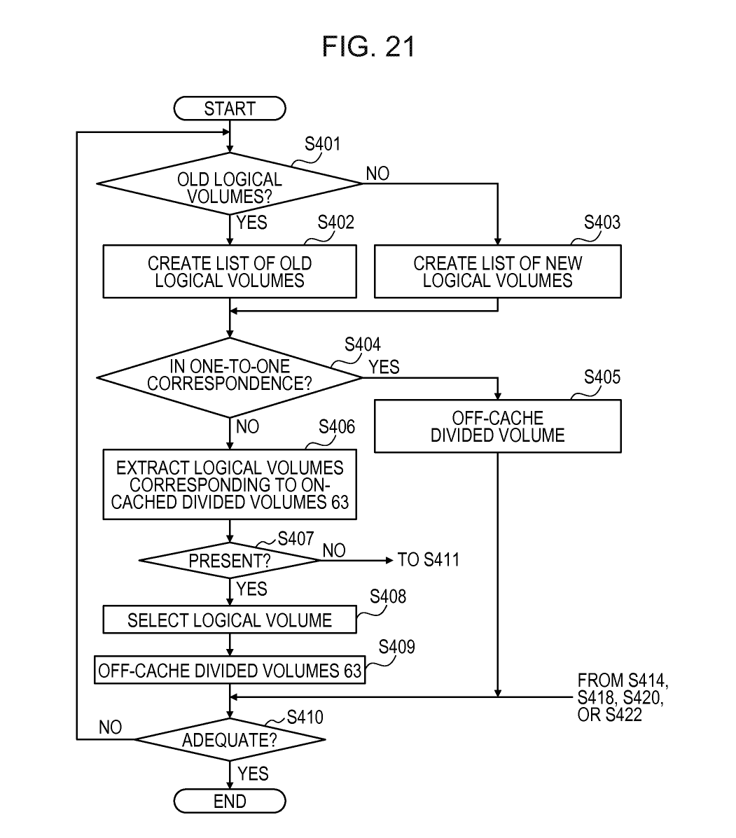

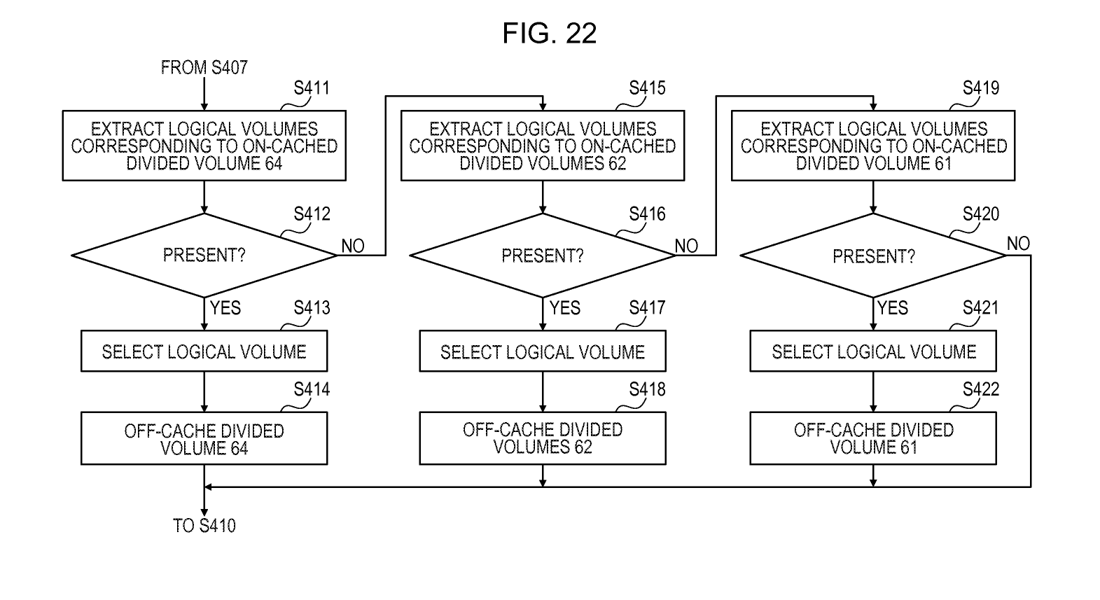

If the mount processing unit 52 determines that the size of the free space in the storage unit 26 is smaller than the size of the divided volume assigned in S103 (No in S104), the mount processing unit 52 outputs a request to perform off-cache processing to the off-cache processing unit 57 (S105). The off-cache processing unit 57 receives this request and performs off-cache processing. Off-cache processing will be described later in detail with reference to FIGS. 21 and 22. When notified that the off-cache processing has been completed, the mount processing unit 52 causes the process to proceed to S106.

If the mount processing unit 52 determines in S104 that the size of the free space in the storage unit 26 is equal to or larger than the size of the divided volume assigned in S103 (Yes in S104), the mount processing unit 52 loads the divided volume assigned in S103 in the storage unit 26 (S106). That is, the mount processing unit 52 reserves a free space with the size of the assigned divided volume and uses the free space for the divided volume assigned in S103.

The mount processing unit 52 then determines that the mount processing has been completed, and sends a completion notification indicating that mounting has been completed to the host apparatus 21 (S107). This terminates the process.

If the mount processing unit 52 determines in S102 that the target logical volume to be mounted and divided volumes are mutually associated (Yes in S102), the mount processing unit 52 references the management information 58 and determines whether certain specific divided volumes among the divided volumes associated with the target logical volume are present (on-cached) in the storage unit 26 (S108). The certain specific divided volumes are a predetermined number of divided volumes starting from the beginning in a plurality of divided volumes corresponding to the target logical volume and the last divided volume, as described above. Specifically, the certain specific divided volumes are the divided volumes 61, 62, and 64. In this determination processing, specifically, the mount processing unit 52 references the “on-cache flag” in the management information 58 and determines whether the certain specific divided volumes are present in the storage unit 26. If the mount processing unit 52 determines that the certain specific divided volumes are present in the storage unit 26 (Yes in S108), the mount processing unit 52 causes the process to proceed to S107.

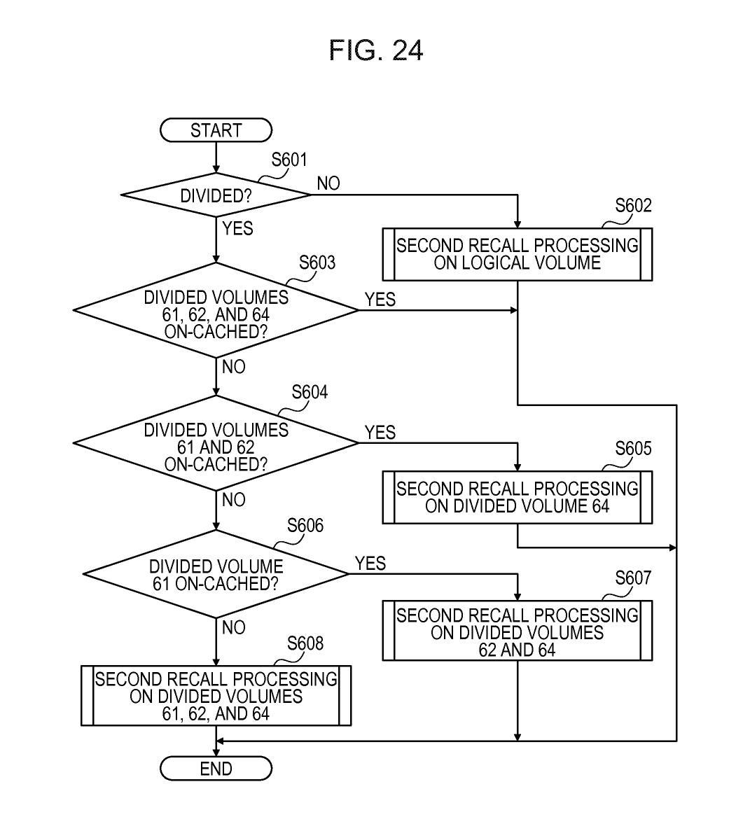

If the mount processing unit 52 determines in S108 that at least one of the certain specific divided volumes is not present in the storage unit 26 (No in S108), the mount processing unit 52 performs first recall processing on the divided volumes among the certain specific divided volumes, that are not present in the storage unit 26 (S109). First recall processing will be described later in detail with reference to FIG. 24. Upon completion of first recall processing, the control unit 25 causes the process to proceed to S107.

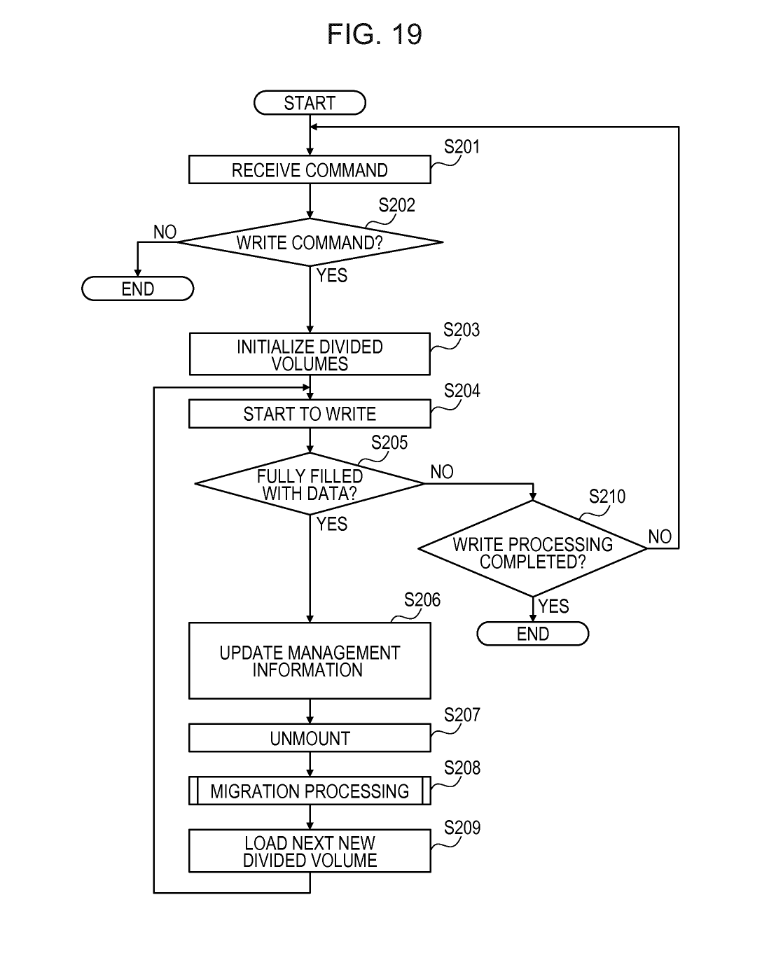

FIG. 19 is a flowchart illustrating details of write processing performed by the write processing unit 54 according to the embodiment.

In FIG. 19, the write processing unit 54 first receives a command from the host apparatus 21 (S201). The write processing unit 54 then determines whether the received command is a WRITE command (S202). If the write processing unit 54 determines that the received command is not a WRITE command (No in S202), the process is terminated.

If the write processing unit 54 determines that the received command is a WRITE command (Yes in S202), the write processing unit 54 first removes the correspondence of divided volumes, which follow a divided volume that includes data at the write position in the logical drive 31 at the current time (at a point in time at which S203 is executed), with the target logical volume (S203). Specifically, the write processing unit 54 extracts, from the management information 58, all entries for the divided volumes that correspond to the target logical volume and follow a divided volume that includes data at the write position at the current time. The write processing unit 54 then deletes the extracted entries. The write processing unit 54 then initializes the divided volumes that correspond to the target logical volume and follow the divided volume that includes data at the write position at the current time and returns the initialized divided volumes to the pool 36. That is, the divided volumes that correspond to the target logical volume and follow the divided volume that includes data at the write position at the current time are handled as not-yet-assigned divided volumes. The above initialization processing may include, for example, processing to delete data of the divided volumes or processing to delete the divided volumes from the storage unit 26.

Next, the write processing unit 54 starts to write target WRITE data to the divided volume that includes data at the write position in the logical drive 31 at the current time (at a point in time at which S204 is executed) (S204). In the following description with reference to FIG. 19, the divided volume to which WRITE data is being written will be referred to as the target divided volume.

After the start of writing to the target divided volume in S204, the write processing unit 54 starts to determine whether the target divided volume has been fully filled with written data (S205).

If the write processing unit 54 determines that the target divided volume has been fully filled with written data (Yes in S205), the write processing unit 54 stops writing to the target divided volume, which is started in S204, and updates the management information 58 (S206). In the update of the management information 58, the write processing unit 54 records information about data written to the target divided volume and identification information about the target divided volume in association with each other in the management information 58. Specifically, the write processing unit 54 extracts an entry that has the “divided volume ID”, in the management information 58, that matches the identification information of the target divided volume. The write processing unit 54 then sets information about the data written in S204 to the “start block number”, “end block number”, and “tape mark count” in the extracted entry.

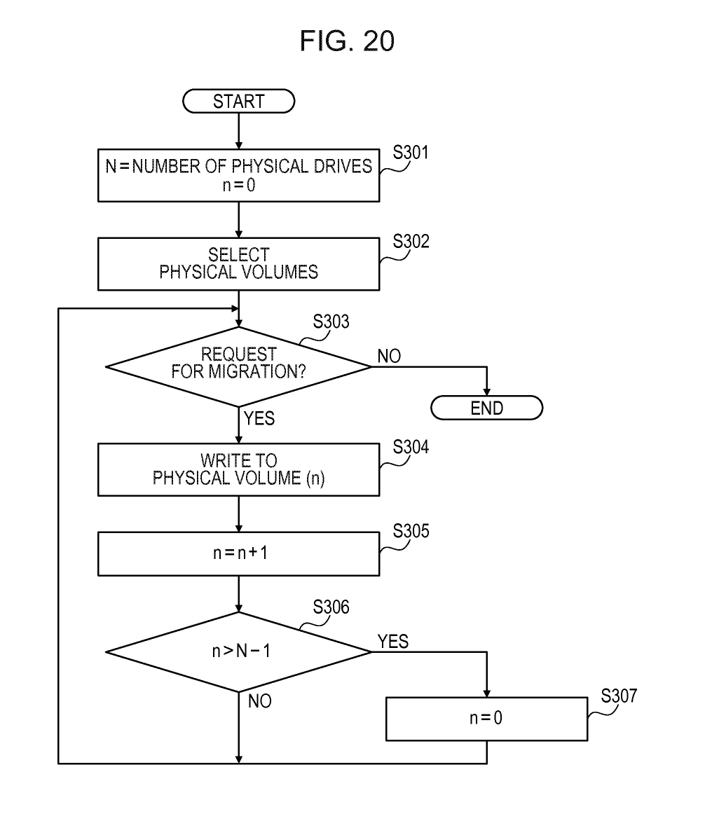

Next, the write processing unit 54 unmounts, from the storage unit 26, an area reserved for the target divided volume (S207). The write processing unit 54 then outputs a request to perform migration processing on the target divided volume unmounted in S207 to the migration processing unit 55 (S208). Migration processing by the migration processing unit 55 will be described later in detail with reference to FIG. 20.

Next, the write processing unit 54 performs load processing for a new divided volume to which the remaining WRITE data is to be written the next time (S209). Load processing for a new divided volume is similar to the processing in S103 to S106 in FIG. 18. The write processing unit 54 then causes the process to return to S204, where the write processing unit 54 starts to write to the new divided volume loaded in S209, starting from a block next to the last block that has been written.

If the write processing unit 54 determines in S205 that even after writing started in S204 is completed, the target divided volume is not fully filled with written data (No in S205), the write processing unit 54 determines whether the write processing has been completed (S210). If the write processing unit 54 determines that the write processing has not been completed (No in S210), the write processing unit 54 causes the process to return to S201. If the write processing unit 54 determines that the write processing has been completed (Yes in S210), the process is terminated.

FIG. 20 is a flowchart illustrating details of migration processing performed by the migration processing unit 55 according to an embodiment.

In FIG. 20, as initialization processing, the migration processing unit 55 sets values of temporary variables used in migration processing before starting migration processing (S301). Specifically, the migration processing unit 55 sets the number of physical drives 34 in variable N and also sets 0 in variable n. The migration processing unit 55 then selects as many physical volumes 35 as the number of physical drives 34 (S302). It is assumed here that the selected physical volumes 35 correspond to physical drives 34 on a one-to-one basis.

Next, the migration processing unit 55 determines whether a request to perform migration processing for a divided volume has been received from the write processing unit 54 (S303). That is, the migration processing unit 55 monitors whether a request to perform migration processing for a divided volume has been received from the write processing unit 54.

If the migration processing unit 55 determines that a request to perform migration processing for a divided volume has been received from the write processing unit 54 (Yes in S303), the migration processing unit 55 writes a divided volume eligible for migration to a physical volume 35 (n) (S304). The physical volume 35 (n) is a physical volume to which the divided volume is to be written by an n-th physical drive.

Next, the migration processing unit 55 increments variable n by one (S305) and determines whether n is greater than (N−1) (S306). If the migration processing unit 55 determines that n is equal to or smaller than (N−1) (No in S306), the migration processing unit 55 causes the process to return to S303. If the migration processing unit 55 determines that n is larger than (N−1) (Yes in S306), the migration processing unit 55 assigns 0 to n (S307) and causes the process to return to S303.

If the migration processing unit 55 determines in S303 that a request to perform migration processing for a divided volume has not been received from the write processing unit 54 (No in S303), the process is terminated.

FIGS. 21 and 22 is an example of a flowchart illustrating details of off-cache processing performed by the off-cache processing unit 57 according to the embodiment.

The off-cache processing unit 57 performs off-cache processing, which will be described with reference to the flow in FIGS. 21 and 22, at a time at which the off-cache processing unit 57 receives a request to perform off-cache processing. The request to perform off-cache processing includes space size information that indicates the size of a free space to be reserved in the storage unit 26 after the off-cache.

In FIG. 21, the off-cache processing unit 57 first references the “last accessed date and time” in the LV list information 59 and determines whether there are on-cached logical volumes accessed last at a date and time earlier than the priority threshold (S401). Specifically, the off-cache processing unit 57 first references the “last accessed date and time” in the LV list information 59 and extracts entries that have the “last accessed date and time” earlier than the priority threshold. The off-cache processing unit 57 then determines whether the extracted entries include entries in which the “on-cache flag” is “T” (True).

If the off-cache processing unit 57 determines that the storage unit 26 includes on-cached logical volumes accessed last at a date and time earlier than the priority threshold (Yes in S401), the off-cache processing unit 57 creates a list of old logical volumes (S402). Specifically, the off-cache processing unit 57 first extracts all entries in which the “last accessed date and time” in the LV list information 59 is earlier than the priority threshold. The off-cache processing unit 57 then selects, from the extracted entries, entries in which the “on-cache flag” is “T” (True), after which the off-cache processing unit 57 compiles their “logical volume IDs” and creates a list of old logical volumes 32. The off-cache processing unit 57 then causes the process to proceed to S404.

If the off-cache processing unit 57 determines in S401 that the storage unit 26 includes no logical volume 32 having a last accessed date and time earlier than the priority threshold (No in S401), the off-cache processing unit 57 creates a list of new logical volumes 32 (S403). Specifically, the off-cache processing unit 57 first extracts all entries in which the “last accessed date and time” in the LV list information 59 is later than the priority threshold. The off-cache processing unit 57 then selects, from the extracted entries, entries in which the “on-cache flag” is “T” (True), after which the off-cache processing unit 57 compiles their “logical volume IDs” and creates a list of new logical volumes 32. The off-cache processing unit 57 then causes the process to proceed to S404.

In S404, the off-cache processing unit 57 determines whether the logical volume 32, in the list created in S402 or S403, that has the earliest last accessed date and time corresponds to a divided volume on a one-to-one basis (S404). This processing is performed to check whether the logical volume 32, in the list, that has the earliest last accessed date and time had not been divided because of its small size. If the off-cache processing unit 57 determines that the logical volume 32, in the list, that has the earliest last accessed date and time corresponds to a divided volume on a one-to-one basis (Yes in S404), the off-cache processing unit 57 off-caches the divided volume (S405). Further, the off-cache processing unit 57 sets, in the management information 58, “F” (False) in the “on-cache flag” that corresponds to the off-cached divided volume. The off-cache processing unit 57 also sets, in the LV list information 59, “F” (False) in the “on-cache flag” that corresponds to the off-cached divided volume. The off-cache processing unit 57 then causes the process to proceed to S410.

If the off-cache processing unit 57 determines that the logical volume 32, in the list, that has the earliest last accessed date and time does not correspond to a divided volume on a one-to-one basis (No in S404), the off-cache processing unit 57 extracts, from the list, logical volumes 32 corresponding to on-cached divided volumes 63 (S406).

Next, the off-cache processing unit 57 determines whether there are, in the list, logical volumes 32 that correspond to on-cached divided volumes 63 (S407). That is, the off-cache processing unit 57 determines whether there are logical volumes 32 extracted in S406. If the off-cache processing unit 57 determines that there is no logical volume 32, in the list, that corresponds to an on-cached divided volume 63 (No in S407), the off-cache processing unit 57 causes the process to proceed to S411 in FIG. 22.

If the off-cache processing unit 57 determines that there are logical volumes 32, in the list, that correspond to on-cached divided volumes 63 (Yes in S407), the off-cache processing unit 57 selects, from the logical volumes 32 extracted in S406, the logical volume 32 that has the earliest last accessed date and time (S408).

Next, the off-cache processing unit 57 off-caches the divided volumes 63 included in a plurality of divided volumes of the logical volume 32 selected in S408 (S409). Further, the off-cache processing unit 57 sets the “on-cache flags”, in the management information 58, that correspond to the off-cached divided volumes 63 to “F” (False).

Next, the off-cache processing unit 57 determines whether a free space reserved in the storage unit 26 is adequate (S410). Specifically, the off-cache processing unit 57 determines whether a free space with a size indicated in the space size information included in the request to perform off-cache processing has been reserved in the storage unit 26. If the off-cache processing unit 57 determines that a free space reserved in the storage unit 26 is adequate (Yes in S410), the process is terminated.

If the off-cache processing unit 57 determines that a free space reserved in the storage unit 26 is not adequate (No in S410), the off-cache processing unit 57 causes the process to return to S401.

In S411 in FIG. 22, the off-cache processing unit 57 extracts, from the list, logical volumes 32 corresponding to an on-cached divided volume 64 (S411).

Next, the off-cache processing unit 57 determines whether there are, in the list, logical volumes 32 that correspond to an on-cached divided volume 64 (S412). That is, the off-cache processing unit 57 determines whether there are logical volumes 32 extracted in S411. If the off-cache processing unit 57 determines that there is no logical volume 32, in the list, that corresponds to an on-cached divided volume 64 (No in S412), the off-cache processing unit 57 causes the process to proceed to S415.

If the off-cache processing unit 57 determines that there are logical volumes 32, in the list, that correspond to an on-cached divided volume 64 (Yes in S412), the off-cache processing unit 57 selects, from the logical volumes 32 extracted in S411, the logical volume 32 that has the earliest last accessed date and time (S413).

Next, the off-cache processing unit 57 off-caches the divided volume 64 included in a plurality of divided volumes of the logical volume 32 selected in S413 (S414). Further, the off-cache processing unit 57 sets, in the management information 58, the “on-cache flag” that corresponds to the off-cached divided volume 64 to “F” (False). The off-cache processing unit 57 then causes the process to proceed to S410 in FIG. 21.

In S415, the off-cache processing unit 57 extracts, from the list, logical volumes 32 corresponding to on-cached divided volumes 62 (S415).

Next, the off-cache processing unit 57 determines whether there are, in the list, logical volumes 32 that correspond to on-cached divided volumes 62 (S416). That is, the off-cache processing unit 57 determines whether there are logical volumes 32 extracted in S415. If the off-cache processing unit 57 determines that there is no logical volume 32, in the list, that corresponds to an on-cached divided volume 62 (No in S416), the off-cache processing unit 57 causes the process to proceed to S419.

If the off-cache processing unit 57 determines that there are logical volumes 32, in the list, that correspond to on-cached divided volumes 62 (Yes in S416), the off-cache processing unit 57 selects, from the logical volumes 32 extracted in S415, the logical volume 32 that has the earliest last accessed date and time (S417).

Next, the off-cache processing unit 57 off-caches the divided volumes 62 included in a plurality of divided volumes of the logical volume 32 selected in S417 (S418). Further, the off-cache processing unit 57 sets the “on-cache flags”, in the management information 58, that correspond to the off-cached divided volumes 62 to “F” (False). The off-cache processing unit 57 then causes the process to proceed to S410 in FIG. 21.

In S419, the off-cache processing unit 57 extracts, from the list, logical volumes 32 corresponding to an on-cached divided volume 61 (S419).

Next, the off-cache processing unit 57 determines whether there are, in the list, logical volumes 32 that correspond to an on-cached divided volume 61 (S420). That is, the off-cache processing unit 57 determines whether there are logical volumes 32 extracted in S419. If the off-cache processing unit 57 determines that there is no logical volume 32, in the list, that corresponds to an on-cached divided volume 61 (No in S420), the off-cache processing unit 57 causes the process to proceed to S410 in FIG. 21.

If the off-cache processing unit 57 determines that there are logical volumes 32, in the list, that correspond to an on-cached divided volume 61 (Yes in S420), the off-cache processing unit 57 selects, from the logical volumes 32 extracted in S419, the logical volume 32 that has the earliest last accessed date and time (S421).

Next, the off-cache processing unit 57 off-caches the divided volume 61 included in a plurality of divided volumes of the logical volume 32 selected in S421 (S422). Further, the off-cache processing unit 57 sets, in the management information 58, the “on-cache flag” that corresponds to the off-cached divided volume 61 to “F” (False). For the logical volume corresponding to the off-cached divided volume 61, the off-cache processing unit 57 also sets the “on-cache flag” in the LV list information 59 to “F” (False). The off-cache processing unit 57 then causes the process to proceed to S410 in FIG. 21.

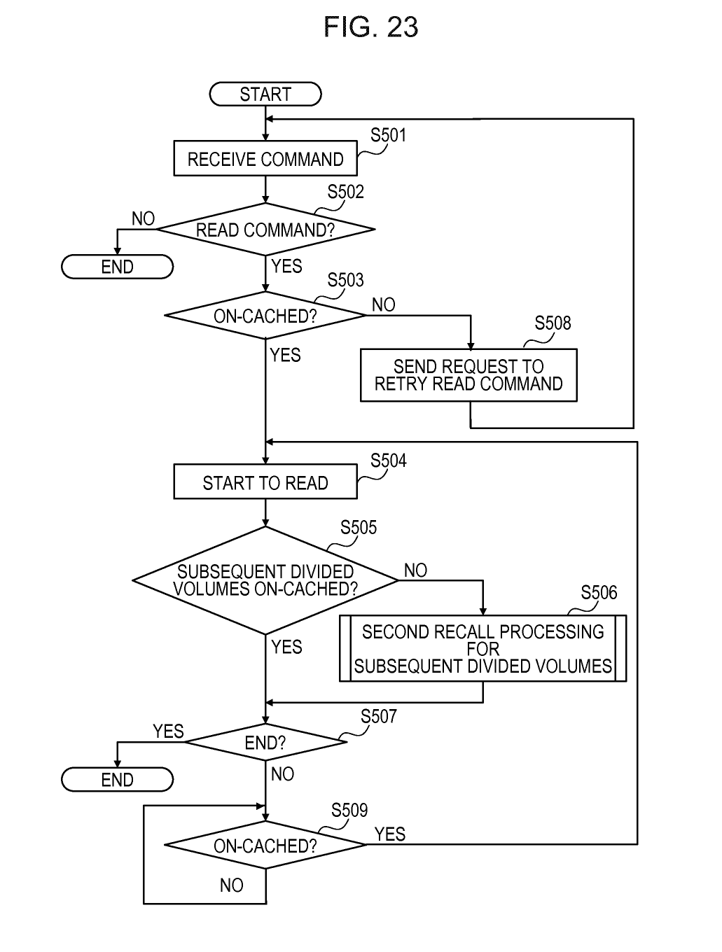

FIG. 23 is a flowchart illustrating details of read processing performed by the read processing unit 56 according to the embodiment.

In FIG. 23, the read processing unit 56 first receives a command from the host apparatus 21 (S501). The read processing unit 56 then determines whether the received command is a READ command (S502). If the read processing unit 56 determines that the received command is not a READ command (No in S502), the process is terminated.

If the read processing unit 56 determines that the received command is a READ command (Yes in S502), the write processing unit 54 determines whether the divided volume having a block ID eligible for reading is on-cached (S503). Specifically, the read processing unit 56 determines whether the divided volume that includes data at the read position in the logical drive 31 at the current time (at a point in time at which S503 is executed) is on-cached. If the read processing unit 56 determines that the divided volume having a block ID eligible for reading is not on-cached (No in S503), the read processing unit 56 sends the host apparatus 21 a request to retry a READ command (S508). The read processing unit 56 then causes the process to return to S501.

If the write processing unit 54 determines that the divided volume having a block ID eligible for reading is on-cached (Yes in S503), the read processing unit 56 starts to read out data stored in the storage unit 26 starting from the read position in the logical drive 31 at the current time (at a point in time at which S504 is executed) and to send the read-out data to the host apparatus 21 (S504). In the following description with reference to FIG. 23, the divided volume that includes data being read from the storage unit 26 will be referred to as a read-in-progress divided volume. The reading out of data from the storage unit 26, which is started in S504, is executed in parallel to processing in S505 to S507.

Next, the read processing unit 56 determines whether three consecutive divided volumes following the read-in-progress divided volume are on-cached (S505). This processing is to monitor whether the three divided volumes following the read-in-progress divided volume become no longer on-cached during the progress of the reading out of data from the storage unit 26, which is started in S504. Here, “consecutive” divided volumes are such that the last block number of the first divided volume and the first block number of the second divided volume are consecutive.

If the read processing unit 56 determines in S505 that the three consecutive divided volumes following the read-in-progress divided volume are on-cached (Yes in S505), the read processing unit 56 causes the process to proceed to S507.

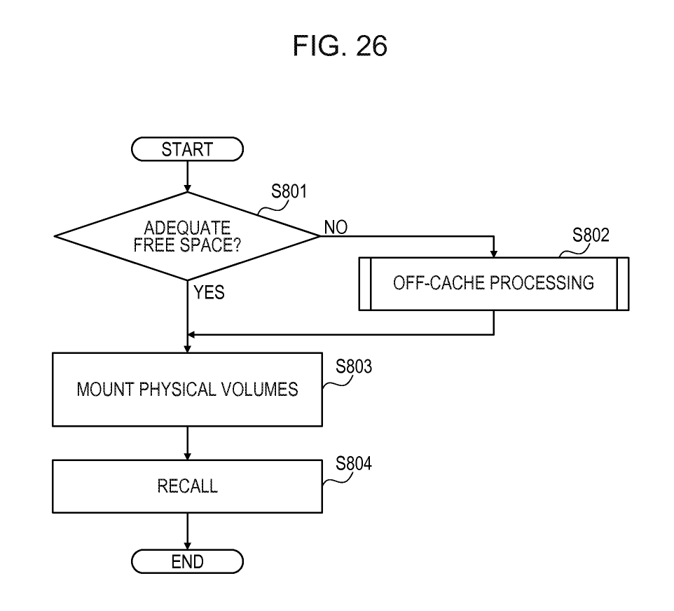

If the read processing unit 56 determines in S505 that the three consecutive divided volumes following the read-in-progress divided volume are not on-cached (No in S505), the read processing unit 56 performs second recall processing so that the three consecutive divided volumes following the read-in-progress divided volume are on-cached (S506). Second recall processing will be described later in detail with reference to FIG. 26.

In processing in S505 and S506, divided volumes following the read-in-progress divided volume are recalled in advance in parallel to the processing for the read-in-progress divided volume. The number of divided volumes handled in S505 and S506 is not limited to 3; any predetermined number of divided volumes may be handled.

In S507, when the reading out of the read-in-progress divided volume has been completed, the read processing unit 56 determines whether all data of the target logical volume 32 to be read out has been read out.

If the read processing unit 56 determines in S507 that all data of the target logical volume 32 has been read out (Yes in S507), the process is terminated.

If the read processing unit 56 determines in S507 that part of data of the target logical volume 32 is not yet read out (No in S507), the read processing unit 56 determines whether a next target divided volume to be read out is on-cached (S509). This processing is to monitor, during the progress of the reading out of data from the storage unit 26 which is started in S504, whether the reading out of the read-in-progress divided volume has been completed before a next target divided volume to be read out is completely recalled in S506. If the read processing unit 56 determines that a next divided volume to be read out is not on-cached (No in S509), the read processing unit 56 waits until the next divided volume to be read out is on-cached. If the read processing unit 56 determines that a next divided volume to be read out is on-cached (Yes in S509), the read processing unit 56 causes the process to proceed to S504, where the read processing unit 56 starts to read out the next target divided volume to be read out.

FIG. 24 is a flowchart illustrating details of first recall processing performed by the mount processing unit 52 according to the embodiment.

In FIG. 24, the mount processing unit 52 first references the management information 58 and determines whether a target logical volume to be mounted has been divided (S601). Specifically, with reference to the management information 58, the mount processing unit 52 determines whether there are at least two entries in which the “logical volume ID” matches information that identifies the target logical volume to be mounted. If there are at least two entries in which the “logical volume ID” matches information that identifies the target logical volume to be mounted, the mount processing unit 52 determines that the logical volume 32 has been divided into a plurality of divided volumes. If there is only one entry in which the “logical volume ID” matches information that identifies the target logical volume to be mounted, the mount processing unit 52 determines that the logical volume 32 has not been divided into a plurality of divided volumes.

If the mount processing unit 52 determines in S601 that a target logical volume to be mounted has not been divided (No in S601), the mount processing unit 52 performs second recall processing in which the logical volume 32 to be mounted is recalled (S602). The logical volume 32 to be recalled is, in other words, a divided volume that corresponds to the logical volume 32 on a one-to-one basis. Second recall processing in S602 will be described later in detail with reference to FIG. 26. Then, the process is terminated.

If the mount processing unit 52 determines in S601 that the target logical volume to be mounted has been divided (Yes in S601), the mount processing unit 52 determines whether the divided volumes 61, 62, and 64 are all on-cached (S603). Specifically, the mount processing unit 52 extracts, from the management information 58, the entries for the divided volumes 61, 62, and 64 of the target logical volume and determines whether the value of the “on-cache flag” in each extracted entry indicates that the relevant divided volume is on-cached. If the mount processing unit 52 determines that the divided volumes 61, 62, and 64 are all on-cached (Yes in S603), the process is terminated.

If the mount processing unit 52 determines that any of the divided volumes 61, 62, and 64 is not on-cached (No in S603), the mount processing unit 52 determines whether the divided volumes 61 and 62 in a plurality of divided volumes of the target logical volume are all on-cached (S604). Specifically, the mount processing unit 52 extracts, from the management information 58, the entries for the divided volumes 61 and 62 of the target logical volume and determines whether the value of the “on-cache flag” in each extracted entry indicates that the relevant divided volume is on-cached. If the mount processing unit 52 determines that the divided volumes 61 and 62 are both on-cached (Yes in S604), the mount processing unit 52 performs second recall processing (S605) to recall the divided volume 64. Second recall processing in S605 will be described later in detail with reference to FIG. 26. Then, the process is terminated.

If the mount processing unit 52 determines that any of the divided volumes 61 and 62 is not on-cached (No in S604), the mount processing unit 52 determines whether the divided volume 61 in a plurality of divided volumes of the target logical volume is on-cached (S606). Specifically, the mount processing unit 52 extracts, from the management information 58, the entry for the divided volume 61 of the target logical volume and determines whether the value of the “on-cache flag” in the extracted entry indicates that the divided volume 61 is on-cached. If the mount processing unit 52 determines that the divided volume 61 is on-cached (Yes in S606), the mount processing unit 52 performs second recall processing to recall the divided volumes 62 and 64 (S607). Second recall processing in S607 will be described later in detail with reference to FIG. 26. Then, the process is terminated.

If the mount processing unit 52 determines that the divided volume 61 is not on-cached (No in S606), the mount processing unit 52 performs second recall processing to recall the divided volumes 61, 62, and 64 (S608). Second recall processing in S608 will be described later in detail with reference to FIG. 26. Then, the process is terminated.

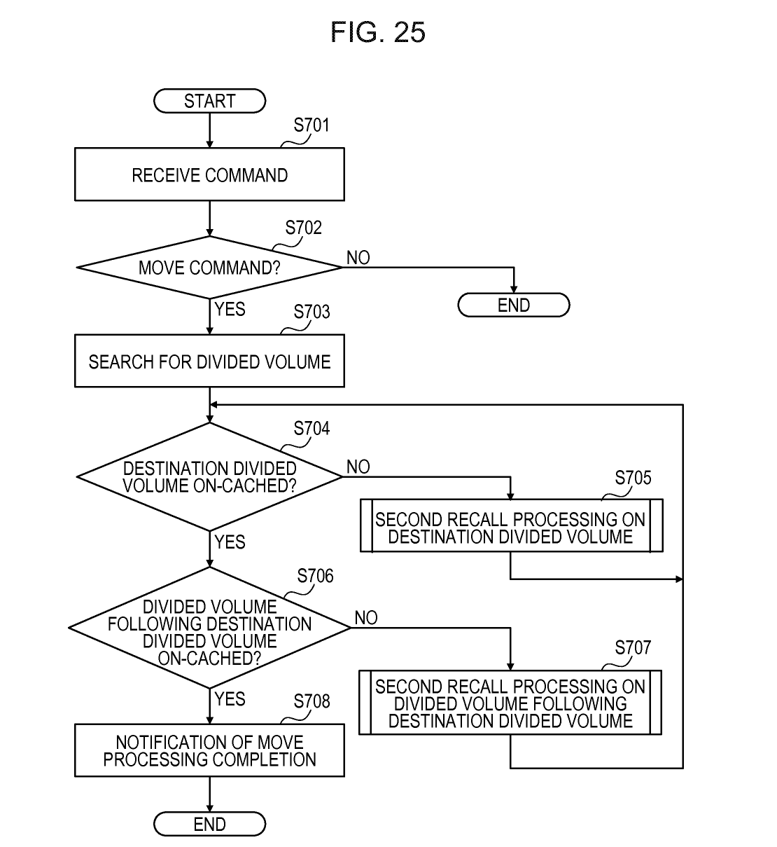

FIG. 25 is a flowchart illustrating details of move processing performed by the move processing unit 53 according to the embodiment.

In FIG. 25, the move processing unit 53 first receives a command from the host apparatus 21 (S701). The move processing unit 53 then determines whether the received command is a move command (S702). If the move processing unit 53 determines that the received command is not a move command (No in S702), the process is terminated.

If the move processing unit 53 determines that the received command is a move command (Yes in S702), the move processing unit 53 references the management information 58 and searches for a divided volume that includes a destination block (S703). Specifically, if the move command includes a destination block ID, the move processing unit 53 searches the management information 58 for a divided volume that includes the destination block ID. That is, the move processing unit 53 extracts, from the management information 58, entries in which the “logical volume ID” matches the information that identifies the target logical volume. The move processing unit 53 then identifies a divided volume that includes a block identified by the destination block ID included in the move command with reference to the “start block number” and the “end block number” in the extracted entries. If the move command includes a tape mark count, the move processing unit 53 searches the management information 58 for a divided volume having a specified number of tape marks. That is, the move processing unit 53 identifies a logical volume that has as many tape marks as the tape mark count included in the move command with reference to the “tape mark count” in the entries of the management information 58, in which the “logical volume ID” matches the information that identifies the target logical volume.

Next, the move processing unit 53 determines whether the destination divided volume identified in the S703 is on-cached (S704). Specifically, the move processing unit 53 references, in the management information 58, the “on-cache flag” in the entry for the destination divided volume and determines whether the destination divided volume is on-cached. If the move processing unit 53 determines that the destination divided volume is not on-cached (No in S704), the move processing unit 53 performs second recall processing to recall the destination divided volume (S705). Second recall processing in S705 will be described later in detail with reference to FIG. 26. Then, the move processing unit 53 causes the process to return to S704.

If the move processing unit 53 determines in S704 that the destination divided volume is on-cached (Yes in S704), the move processing unit 53 determines whether a divided volume that follows the destination divided volume is on-cached (S706). Specifically, the move processing unit 53 references, in the management information 58, the “on-cache flag” in the entry for the divided volume that follows the destination divided volume and determines whether the divided volume that follows the destination divided volume is on-cached. If the move processing unit 53 determines that the divided volume that follows the destination divided volume is not on-cached (No in S706), the move processing unit 53 performs second recall processing to recall the divided volume that follows the destination divided volume (S707). Second recall processing in S707 will be described later in detail with reference to FIG. 26. Then, the move processing unit 53 causes the process to return to S704.

If the move processing unit 53 determines in S706 that the divided volume that follows the destination divided volume is on-cached (Yes in S706), the move processing unit 53 determines that the move processing has been completed and sends the host apparatus 21 a movement completion notification indicating that the move processing has been completed (S708). Then, the process is terminated.

FIG. 26 is a flowchart illustrating details of second recall processing according to the embodiment. This recall processing is invoked in S506 in the flow illustrated in FIG. 23, in S602, S605, S607, and S608 in the flow illustrated in FIG. 24, and in S705 and S707 in the flow illustrated in FIG. 25. Although an operation in a case in which second recall processing is performed by the mount processing unit 52 in the process illustrated in FIG. 24 will be described below, the description also applies to an operation by the read processing unit 56 in the process illustrated in FIG. 23 and an operation by the move processing unit 53 in the process illustrated in FIG. 25.

In FIG. 26, the mount processing unit 52 first determines whether the size of a free space in the storage unit 26 is equal to or larger than the size of a divided volume to be recalled (S801). If the mount processing unit 52 determines that the size of a free space in the storage unit 26 is equal to or larger than the size of a divided volume to be recalled (Yes in S801), the mount processing unit 52 causes the process to proceed to S803.

If the mount processing unit 52 determines that the size of a free space in the storage unit 26 is smaller than the size of a divided volume to be recalled (No in S801), the mount processing unit 52 outputs a request to perform off-cache processing, which has been described in detail with reference to FIGS. 21 and 22, to the off-cache processing unit 57 (S802). The mount processing unit 52 specifies the size of the divided volume to be recalled in the request to perform off-cache processing. The mount processing unit 52 then causes the process to proceed to S803.

In S803, the mount processing unit 52 performs control so that physical volumes 35 in which divided volumes to be recalled are stored are mounted in their respective physical drives 34 (S803). Specifically, the mount processing unit 52 issues a command so that physical volumes 35 in which divided volumes to be recalled are stored are mounted in their respective physical drives 34 in the tape library apparatus 24.

Next, from each physical volume 35 mounted in S803, the mount processing unit 52 performs recall processing in which the mount processing unit 52 reads out data of divided volumes to be recalled and stores the read-out data in the storage unit 26 (S804). The mount processing unit 52 also sets, in the management information 58, “T” (True) to the “on-cache flag” corresponding to each recalled divided volume. If the value of the “on-cache flag”, in the LV list information 59, that corresponds to the logical volume corresponding to the recalled divided volumes is “F” (False), the mount processing unit 52 set “T” (True) to the “on-cache flag”. Then, the process is terminated.

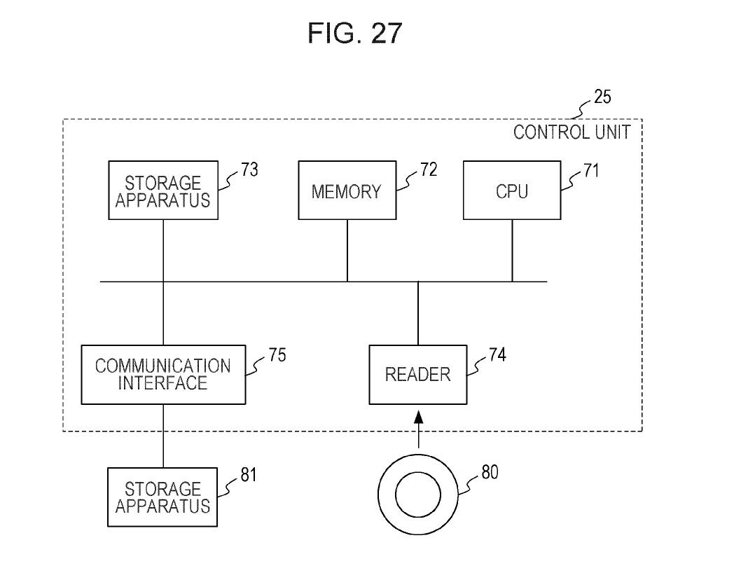

Next, an exemplary hardware configuration of the control unit 25 in the virtual tape apparatus 23 will be described. FIG. 27 illustrates an exemplary hardware configuration of the control unit 25 according to the embodiment.

As described in FIG. 27, the control unit 25 includes a central processing unit (CPU) 71, a memory 72, a storage apparatus 73, a reader 74, and a communication interface 75. The CPU 71, memory 72, storage apparatus 73, reader 74, and communication interface 75 are mutually connected through a bus.

Using the memory 72, the CPU 71 executes a program in which procedures of the flowcharts described above are coded to provide part or all of the functions of the mount processing unit 52, move processing unit 53, write processing unit 54, and migration processing unit 55. The CPU 71 also provides part or all of the functions of the read processing unit 56 and off-cache processing unit 57 in a similar way.

The memory 72 is, for example, a semiconductor memory. The memory 72 includes a random access memory (RAM) area and a read-only memory (ROM) area. The storage apparatus 73 is, for example, a hard disk drive. However, the storage apparatus 73 may be a flash memory or another semiconductor memory. The storage apparatus 73 may be an external storage apparatus. The storage apparatus 73 provides part or all of the functions of the management information storage unit 51.

The reader 74 accesses a removable recoding medium 80 in response to a command received from the CPU 71. The removable recoding medium 80 is implemented by, for example, a semiconductor device (such as universal serial bus (USB) memory), a medium (such as a magnetic disk) to and from which information is magnetically input and output, or a medium (such as a compact disc-read-only memory (CD-ROM) or digital versatile disc (DVD)) to and from which information is optically input or output. The reader 74 may be excluded from the control unit 25.

The communication interface 75 communicates with the host apparatus 21 and tape library apparatus 24 through a network, in response to an instruction received from the CPU 71. The communication interface 75 also communicates with a storage apparatus 81 through a network or a bus.

The program according to the embodiment is provided to the control unit 25 in, for example, any of the following ways.

(1) Preinstalled in the storage apparatus 73

(2) Provided through the removable recoding medium 80

(3) Provided through the communication interface 75 from a program server (not illustrated)

The storage apparatus 81 is a storage apparatus such as a hard disk drive or a disk array apparatus. The storage apparatus 81 may be a flash memory or another semiconductor memory. The storage apparatus 81 provides part or all of the functions of the storage unit 26.

Part of the control unit 25 according to the embodiment may be implemented by hardware or a combination of software and hardware.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A media control device, comprising:
a processor configured to
read out, in response to a first request received from an information processing apparatus, part of a plurality of divided data items from recording media and store the part of the plurality of divided data items in a first storage unit, the plurality of divided data items being obtained by dividing a first set of data and stored in the recording media, and
access, in response to a second request received from the information processing apparatus, one divided data item stored in the first storage unit.

2. The media control device according to claim 1, further comprising:
a second storage unit configured to
store management information in which the first set of data is associated with the plurality of divided data items,
wherein
the processor is configured to
read out the part of the plurality of divided data items from the recording media in accordance with the management information and store the part of the plurality of divided data items in the first storage unit.

3. The media control device according to claim 2, wherein
the processor is configured to
divide, upon receipt of a WRITE request to write target data from the information processing apparatus, the target data to create a first plurality of divided data items,
record, in the management information, first information in which the target data is associated with the first plurality of divided data items, and
store the first plurality of divided data items in the recording media concurrently.

4. The media control device according to claim 1, wherein
the second request is an OVERWRITE request to overwrite the first set of data, starting from a beginning, and
the processor is configured to
read out, in response to the first request, a first divided data item that includes a top block of the first set of data from the recording media and store the first divided data item in a first area of the first storage unit, and
perform, in response to the second request, overwrite processing on the first area.

5. The media control device according to claim 1, wherein
the second request is a READ request to read out data starting from a beginning of the first set of data, and
the processor is configured to
read out, in response to the first request, a first divided data item that includes a top block of the first set of data from the recording media and store the first divided data item in the first storage unit,
read out, in response to the second request, first data from the top block included in the first divided data item stored in the first storage unit and send the first data to the information processing apparatus, and
read out, in response to the second request, second divided data items that follow the first divided data item from the recording media sequentially and store the second divided data items in the first storage unit.

6. The media control device according to claim 2, wherein
the management information further includes control information that indicates locations on a virtual medium, at which the respective divided data items are stored,
the second request is an access request that includes information indicating a first access location on the virtual medium, at which data to be accessed is stored, and
the processor is configured to
read out, in response to the second request, a first divided data item that includes data stored at the first access location from the recording media in accordance with the control information and store the first divided data item in the first storage unit.

7. The media control device according to claim 1, wherein
the processor is configured to
delete, if the first storage unit does not have free space large enough to store the part of the plurality of divided data items, first divided data items sequentially from the first storage unit, the first divided data items being located between a divided data item that includes a top block of a second set of data and a divided data item that includes an end block of the second set of data until the first storage unit has free space large enough to store the part of the plurality of divided data items.

8. A control method, comprising:
reading out by a computer, in response to a first request received from an information processing apparatus, part of a plurality of divided data items from recording media and storing the part of the plurality of divided data items in a first storage unit, the plurality of divided data items being obtained by dividing a first set of data and stored in the recording media, and
accessing, in response to a second request received from the information processing apparatus, one divided data item stored in the first storage unit.

9. A computer-readable recording medium having stored therein a program that causes a computer to execute a process, the process comprising:
reading out, in response to a first request received from an information processing apparatus, part of a plurality of divided data items from recording media and storing the part of the plurality of divided data items in a first storage unit, the plurality of divided data items being obtained by dividing a first set of data and stored in the recording media, and
accessing, in response to a second request received from the information processing apparatus, one divided data item stored in the first storage unit.
